(19) United States
(12) Patent Application Publication
(10) Pub. No.: US 2023/0176859 A1
(43) Pub. Date: Jun. 8, 2023

(54) AUTOMATED METHODS AND SYSTEMS FOR PREDICTING BEHAVIOR OF A DISTRIBUTED APPLICATION IN RESPONSE TO A PROPOSED CHANGE TO THE DISTRIBUTED APPLICATION

(71) Applicant: VMware, Inc., Palo Alto, CA (US)

(72) Inventors: Nicholas Kushmerick, Seattle, WA (US); Illia Pantechev, Sofia (BG)

(73) Assignee: VMware, Inc., Palo Alto, CA (US)

(21) Appl. No.: 17/543,343

(22) Filed: Dec. 6, 2021

(51) Int. Cl. G06F 8/70; G06N 3/04

(52) U.S. Cl. CPC G06F 8/70; G06N 3/0454

(57) ABSTRACT

This disclosure is directed to automated computer-implemented methods that predict behavior of a distributed application in response to a proposal to add a candidate application component to a distributed computing environment in which the distributed application is executed. The automated computer-implemented methods perform machine learning to predict whether the candidate application component will decrease performance of the distributed application. The candidate application component is automatically added to the distributed computing environment if the predicted performance of the distributed application is acceptable.

### TECHNICAL FIELD

The present disclosure is directed to predicting the behavior of a distributed application in response to a proposed change to the distributed application.

### BACKGROUND

Electronic computing has evolved from primitive, vacuum-tube-based computer systems, initially developed during the 1940s, to modern electronic computing systems in which large numbers of multi-processor computer systems, such as server computers, workstations, and other individual computing systems are networked together with large-capacity data-storage devices and other electronic devices to produce distributed computing systems that communicate with each other, provide enormous computational bandwidths and data-storage capacities. These large, distributed computing systems are typically housed in data centers and made possible by advances in computer networking, distributed operating systems and applications, data-storage appliances, computer hardware, and advances in software technologies.

Enterprises, governments, and other organizations now conduct commerce, provide services over the Internet, and process large volumes of data using distributed applications executed in distributed computing systems. A distributed application comprises multiple software components that are executed on one or more server computers. The software components communicate and coordinate actions to appear as a single coherent application to an end user. Consider, for example, a distributed application that provides banking services to users via a bank website or a mobile application (“mobile app”) executed on a mobile device. One component provides front-end services that enable users to input banking requests and receive responses to requests via the website or the mobile app. Each user only sees the features provided by the website or mobile app. Other components of the distributed application perform back-end services that are executed in the distributed computing system. These services include processing user banking requests, maintaining data storage, and retrieving user information from data storage.

Virtualization has made a major contribution to executing distributed applications in a distributed computing system. Virtualization provides for the creation of software-based, or virtual, representations of server computers, data-storage devices, and networks. For example, a virtual computer system, known as a virtual machine (“VM”), is a self-contained application and operating system implemented in software. Software components of a distributed application may be executed separately in VMs. A VM may be created or destroyed on demand and may be migrated from one physical server computer to another in a data center. Virtualization has enabled scaling of distributed applications and distributed computing systems to meet changing user demand by increasing or decreasing the number of VMs.

In recent years, management tools have been developed to manage distributed applications executing in a distributed computing system. Managing a distributed application executed on a cluster of server computers, for example, involves adding server computers, migrating VMs to different server computers within the cluster, scaling up and down the number VMs to meet changing demands, disconnecting server computers, changing server computer parameters, such as adding memory and upgrading server computer software. These changes are made to resolve cluster issues, such as poor performance, satisfy security policies, plan for future computational demands (e.g., a seasonal increase in sales), and reclaim wasted resources (e.g., resources that are idle when demand drops). However, many of these changes may have unintended consequences. For example, creating additional VMs of a distributed application to handle an increase in demand for services may have the unintended consequence of creating contention for physical CPUs and memory of a cluster, increasing network traffic beyond capacity of the cluster network, or exceeding data storage limits, all of which slow performance of the distributed application executing on the cluster. As another example, adding a server computer to a cluster already executing a distributed application may increase input/output operations per unit time for certain VMs, but such an addition may increase cluster network traffic beyond the network's capacity, creating congestion that ultimately slows performance of the distributed application.

Changes to a distributed computing system used to run a distributed application can lead to outages and slowdowns. Organizations cannot afford downtime or slow performance of their applications because performance issues frustrate users, damage a brand name, result in lost revenue, and deny people access to vital services. The problems described above typically arise because existing management tools are not able to predict the impact such changes ma) have on execution of a distributed application. As a result, administrators and application owners are slow to execute important changes to a distributing computing environment out of fear that a change may negatively impact performance of their distributed applications. Administrators and distributed application owners seek automated management tools that can predict the behavior of a distributed application in response to proposed changes to the distributed application and/or the distributed computing system used to execute the distributed application.

### SUMMARY

This disclosure is directed to automated computer-implemented methods that predict behavior of a distributed application in response to a proposal to add a candidate application component to a distributed computing environment in which the distributed application is executed and automatically add the candidate application component to the distributed computing environment if the candidate application component does not decrease performance of the distributed application. The automated methods construct a graph model of the distributed computing environment. The graph is partitioned into subgraphs based on a user-selected rule for partitioning the distributed computing environment into subsystems. Each subgraph is a model of a different subsystem of objects of the distributed computing environment. For each subgraph, machine learning is used to generate corresponding key performance indicators (“KPIs”) that predict performance of the subsystem in response to adding the candidate application component to the subsystem. The candidate application component is automatically added to the subsystem with the best predicted performance indicated by the corresponding KPIs. The candidate application component is automatically rejected if the predicted performance of the distributed application decreases.

### DESCRIPTION OF THE DRAWINGS

FIG. 1 shows an architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machine (“VM”) and VM execution environments.

FIG. 6 shows an example of an open virtualization format package.

FIG. 7 shows example virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows an example server computer used to host three containers.

FIG. 12 shows an approach to implementing containers on a VM.

FIG. 13 shows an example of a distributed application that runs in VMs of a virtualization layer that, in turn, runs in a physical data center.

FIG. 14 shows a plot of an example metric.

FIG. 15 shows a table of types of data collected by a management server.

FIG. 16 shows an example graph 1600 comprising five node and seven edges.

FIG. 17 shows an example of a graph of the distributed computing environment of objects and relationships described above with reference to FIG. 15.

FIG. 18A shows plots of three examples of unsynchronized metrics.

FIG. 18B shows a plot of metric values synchronized to a general set of uniformly spaced time stamps.

FIG. 19 shows an example of pairs of objects that influence one another.

FIG. 20 shows an example partition of the graph in FIG. 17 into subgraphs based on objects that influence one another.

FIG. 21 shows an example of the graph in FIG. 17 partitioned into subgraphs based on hosts that receive electrical power from different electrical power sources.

FIG. 22 shows an example of the graph in FIG. 17 partitioned into subgraphs based on clusters.

FIG. 23A shows an example of a flattened subgraph formed from nodes of a subgraph in FIG. 22.

FIG. 23B shows an example of a flattened subgraph formed from nodes of a subgraph in FIG. 22.

FIGS. 24A-24B show examples of forming fragments of a flattened subgraph.

FIG. 25 shows an example of aggregating metrics of a VM to obtain corresponding fragment metrics of a fragment of a flattened subgraph.

FIG. 26 shows an example of metrics of a VM assigned as fragment metrics of a fragment.

FIG. 27 shows examples candidate flattened subgraphs formed from adding a fragment the flattened subgraphs in FIG. 23.

FIG. 28A shows a graph representation of an example neural network.

FIG. 28B is an example pseudo-code for multilayer feed-forward neural networks that executes learning through back propagation.

FIG. 28C shows an example of a simple neural network with an input layer composed of two values and an output layer composed of a single value.

FIG. 29 shows an example of an input layer and an output layer for training a neural network of a subgraph.

FIG. 30 shows an example of aggregating fragment metrics of a flattened subgraph.

FIG. 31 shows an example of an input layer and an output layer for training a neural network of a candidate flattened subgraph.

FIG. 32 shows an example of aggregating fragment metrics of a flattened subgraph.

FIG. 33 shows an example of training a neural network with fragments of flattened subgraph and training a neural network for a candidate fragment of the flattened subgraph.

FIG. 34 shows an example of training a neural network with fragments of flattened subgraph and training a neural network for a candidate fragment of the flattened subgraph.

FIG. 35 shows an example of using trained neural networks obtained in FIG. 33 to compute predicted KPIs for each fragment of a candidate flattened subgraph in FIG. 27.

FIG. 36 shows an example of using trained neural networks obtained in FIG. 34 to compute predicted KPIs for each fragment of a candidate flattened subgraph in FIG. 27.

FIG. 37 shows an example of two VMs added to a cluster of server computers.

FIG. 38 shows a graph of a distributed computing environment.

FIG. 39 is a flow diagram of a method for predicting behavior of a distributed application and adjust a distributed computing environment based on the predicted behavior.

FIG. 40 is a “train neural networks for each subgraph” procedure performed in FIG. 39.

FIG. 41 is a flow diagram of “train a neural network (NNₖ) for Fragmentₙₖ” procedure performed in FIG. 40.

FIG. 42 is a flow diagram of “train a neural network (NN_{kX}) for Fragment_{X}” procedure performed in FIG. 40.

FIG. 43 is a flow diagram of “compute predicted KPIs for each subgraph based on corresponding neural networks” procedure performed in FIG. 39.

FIG. 44 is a flow diagram of “reject the proposed change or adjust the distributed computing environment to accept the proposed change based on the predicted KPIs” procedure performed in FIG. 39.

### DETAILED DESCRIPTION

This disclosure presents automated computer-implemented methods and systems that predict behavior of a distributed application in response to proposed changes to the distributed application. In a first subsection, computer hardware, complex computational systems, and virtualization are described. Automated computer-implemented methods and systems that predict behavior of a distributed application are described in a second subsection.

### Computer Hardware, Complex Computational Systems, and Virtualization

The term “abstraction” as used to describe virtualization below is not intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces.

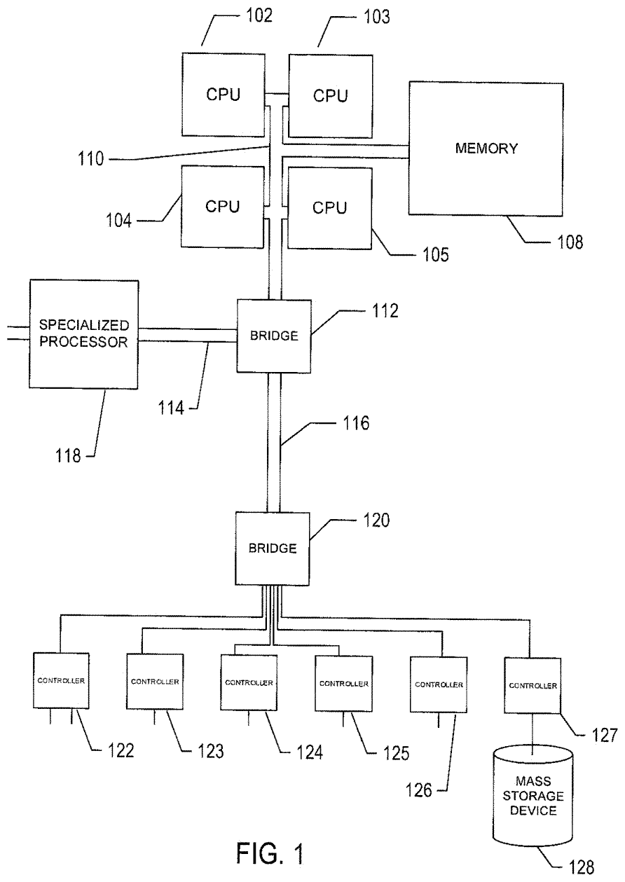

FIG. 1 shows a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of server computers and workstations, and higher-end mainframe computers, but may also include a plethora of various types of special-purpose computing devices, including data-storage systems, communications routers, network nodes, tablet computers, and mobile telephones.

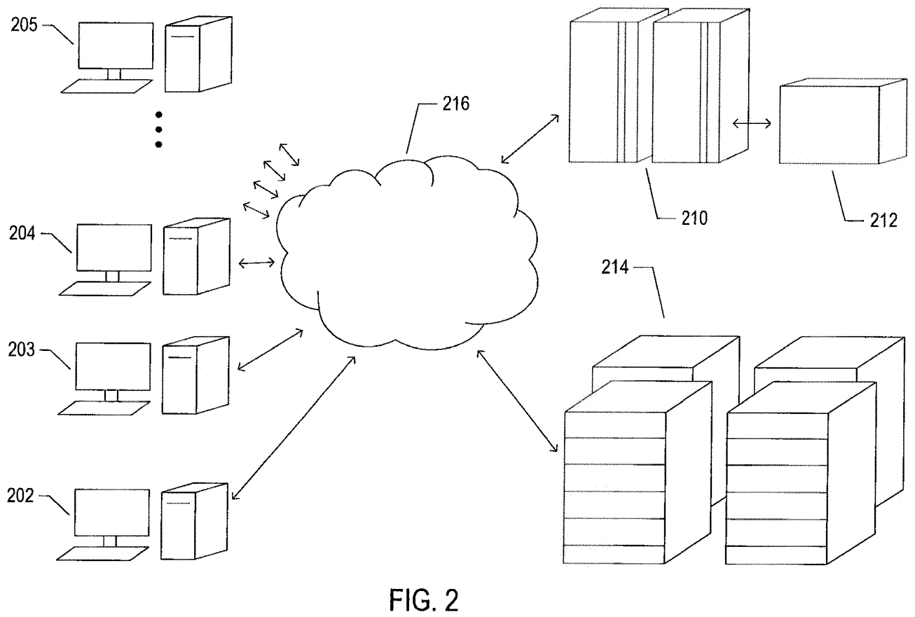

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted server computers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web server computers, back-end computer systems, and data-storage systems for serving web pages to remote customers, receiving orders through the web-page interface, processing the orders, tracking completed orders, and other myriad different tasks associated with an e-commerce enterprise.

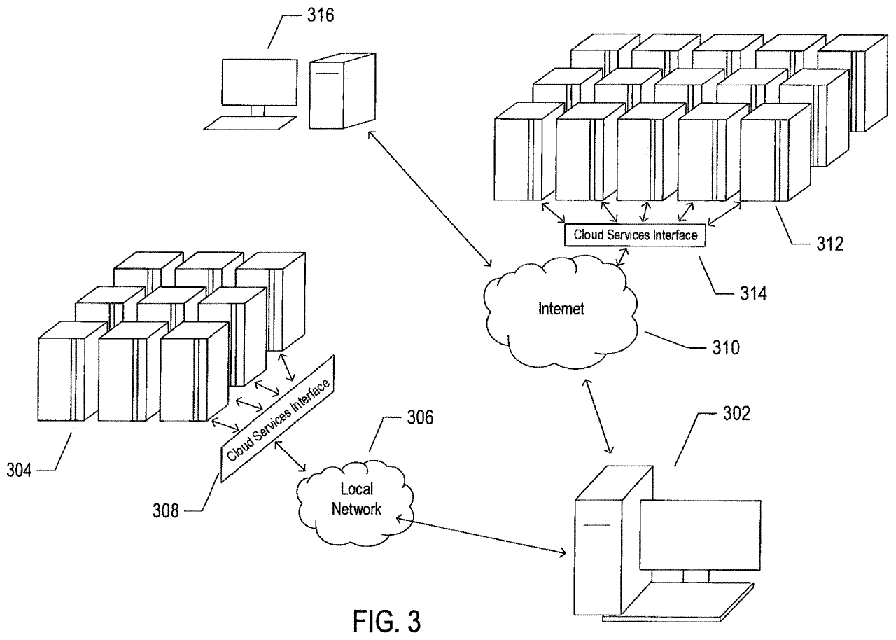

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers perform any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

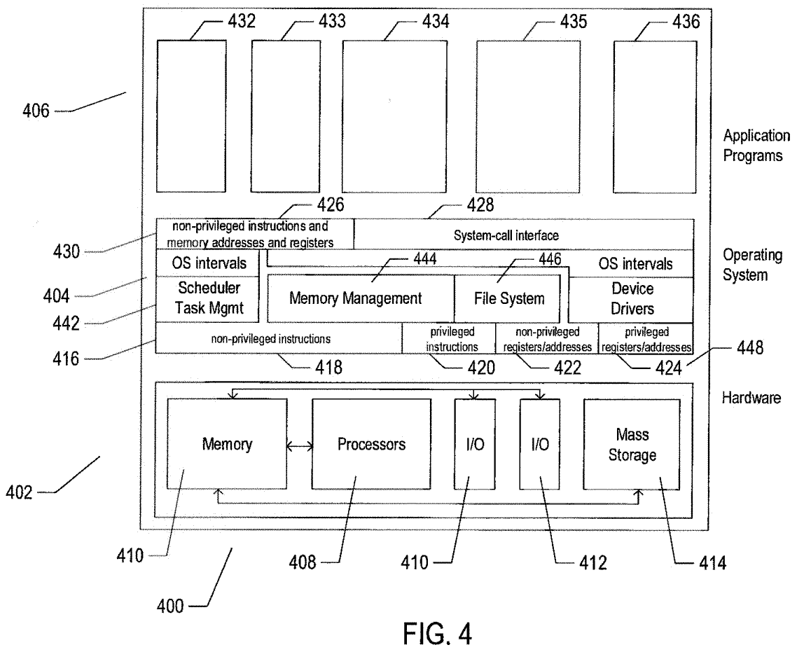

FIG. 4 shows generalized hardware and applications of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 446 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

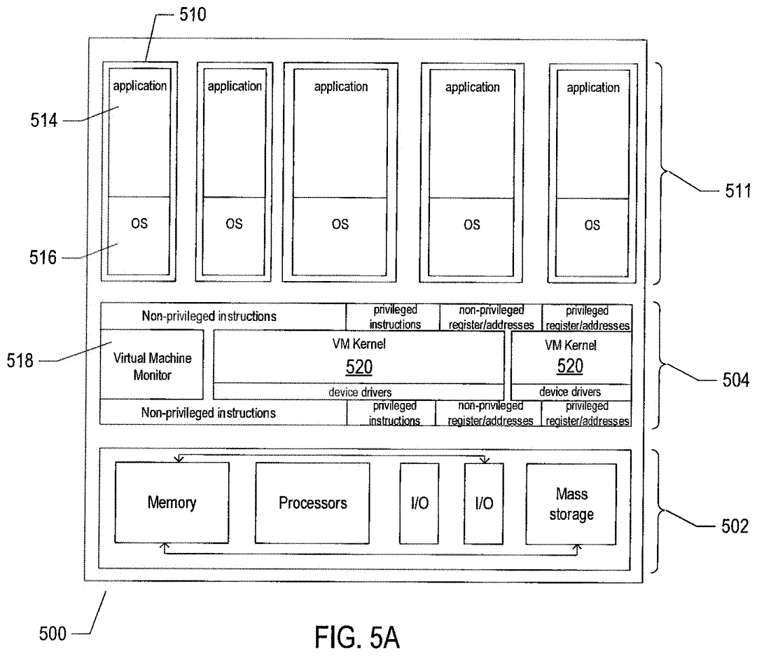

For the above reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtualization layer 504 that interfaces through a virtualization-layer/hardware-layer interface, equivalent to interface 416 in FIG. 4, to the hardware. The virtualization layer 504 provides a hardware-like interface to VMs, such as VM 510, in a virtual-machine layer 511 executing above the virtualization layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtualization layer interface 504 rather than to the actual hardware interface. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization layer 504 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization layer 504, the accesses result in execution of virtualization-layer code to simulate or emulate the privileged devices. The virtualization layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 504 in FIG. 5A. The hardware-layer interface 552, equivalent to interface 416 in FIG. 4, provides an execution environment for VMs 556-558, each including one or more application programs or other higher-level computational entities packaged together with a guest operating system.

In FIGS. 5A-5B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

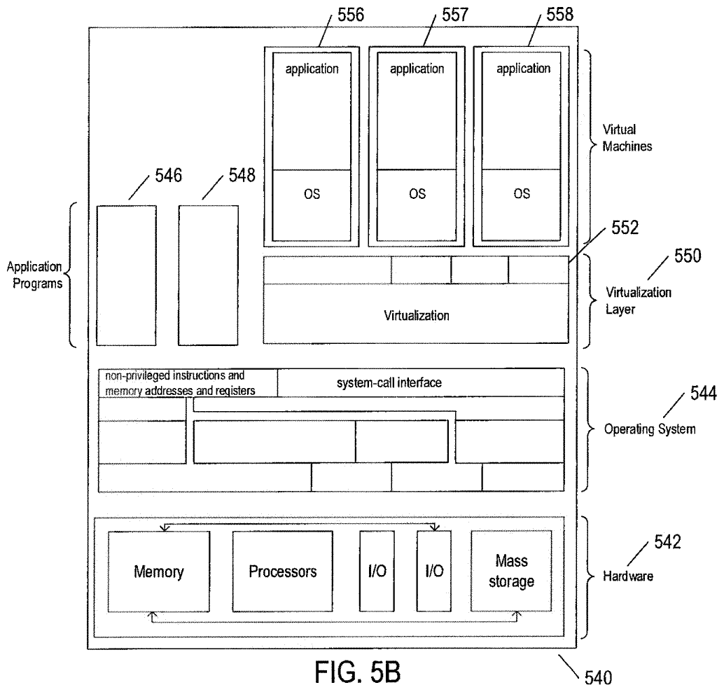

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all the virtual disks included in the OVF package, a network section 630 that includes meta information about all the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing. XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or eliminated by packaging applications and operating systems together as VMs and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers.

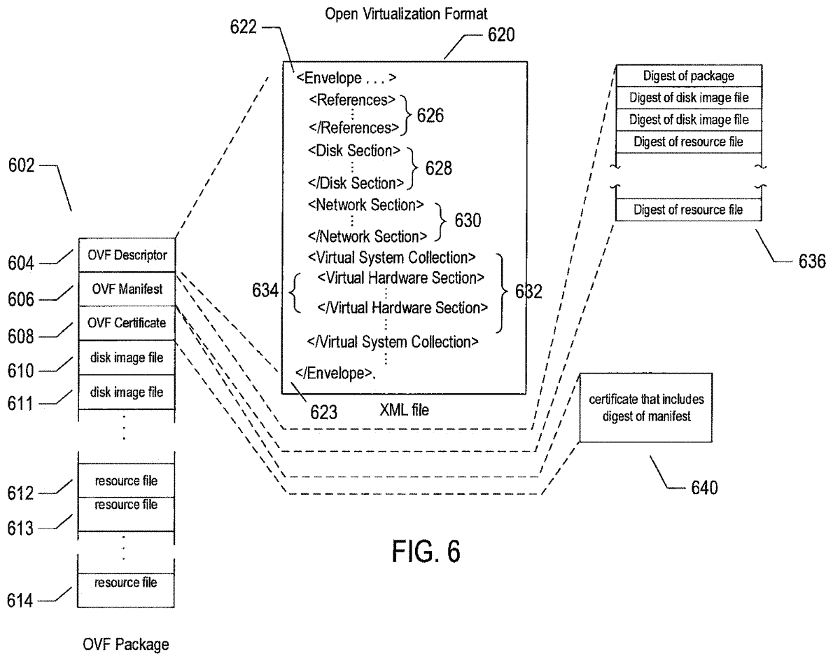

FIG. 7 shows virtual data centers provided as an abstraction of underlying physical-data-center hardware components. In FIG. 7, a physical data center 702 is shown below a virtual-interface plane 704. The physical data center consists of a virtual-data-center management server computer 706 and any of various different computers, such as PC 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight server computers and a mass-storage array. The individual server computers, such as server computer 710, each includes a virtualization layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of server computers directly interconnected by a local area network.

The virtual-data-center management interface allo % ss provisioning and launching of VMs with respect to device pools, virtual data stores, and virtual networks, so that virtual-data-center administrators need not be concerned with the identities of physical-data-center components used to execute particular VMs. Furthermore, the virtual-data-center management server computer 706 includes functionality to migrate running VMs from one server computer to another in order to optimally or near optimally manage device allocation, provides fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual server computers and migrating VMs among server computers to achieve load balancing, fault tolerance, and high availability.

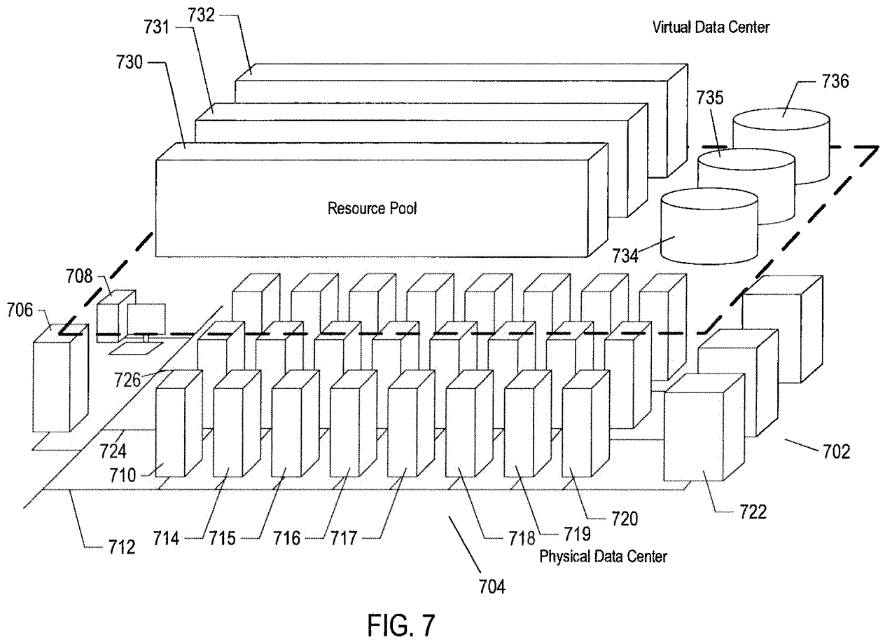

FIG. 8 shows virtual-machine components of a virtual-data-center management server computer and physical server computers of a physical data center above which a virtual-data-center interface is provided by the virtual-data-center management server computer. The virtual-data-center management server computer 802 and a virtual-data-center database 804 comprise the physical components of the management component of the virtual data center. The virtual-data-center management server computer 802 includes a hardware layer 806 and virtualization layer 808 and runs a virtual-data-center management-server VM 810 above the virtualization layer. Although shown as a single server computer in FIG. 8, the virtual-data-center management server computer (“VDC management server”) may include two or more physical server computers that support multiple VDC-management-server virtual appliances. The virtual-data-center management-server VM 810 includes a management-interface component 812, distributed services 814, core services 816, and a host-management interface 818. The host-management interface 818 is accessed from any of various computers, such as the PC 708 shown in FIG. 7. The host-management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the server computers of the physical data center that is abstracted to a virtual data center by the VDC management server computer.

The distributed services 814 include a distributed-device scheduler that assigns VMs to execute within particular physical server computers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server computer, and restarts the VM on the different physical server computer from a virtual-machine state recorded when execution of the VM was halted. The distributed services 814 also include a distributed backup service that provides centralized virtual-machine backup and restore.

The core services 816 provided by the VDC management server VM 810 include host configuration, virtual-machine configuration, virtual-machine provisioning, generation of virtual-data-center alerts and events, ongoing event logging and statistics collection, a task scheduler, and a device-management module. Each physical server computers 820-822 also includes a host-agent VM 828-830 through which the virtualization layer can be accessed via a virtual-infrastructure application programming interface (“API”). This interface allows a remote administrator or user to manage an individual server computer through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server computer. The virtual-data-center agents relay and enforce device allocations made by the VDC management server VM 810, relay virtual-machine provisioning and configuration-change commands to host agents, monitor and collect performance statistics, alerts, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant-associated VDCs that can each be allocated to an individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

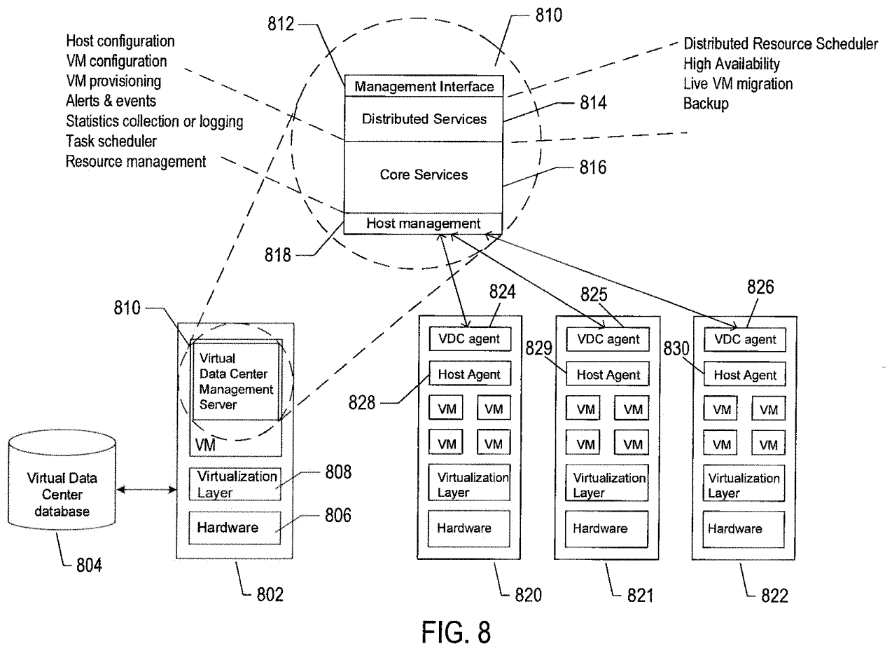

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director server computers 920-922 and associated cloud-director databases 924-926. Each cloud-director server computer or server computers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools, and interfaces for configuring and managing tenant organizations, tools, and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

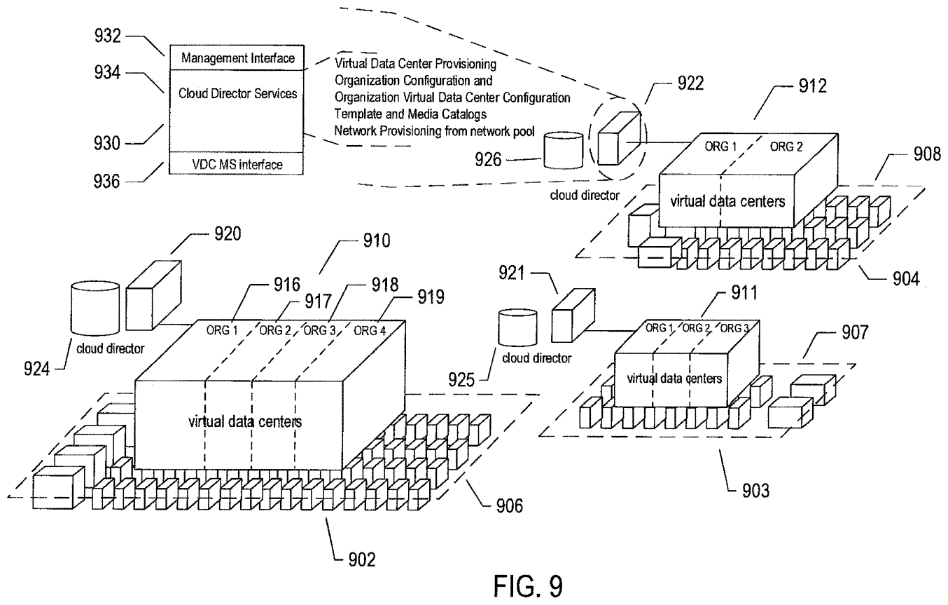

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

As mentioned above, while the virtual-machine-based virtualization layers, described in the previous subsection, have received widespread adoption and use in a variety of different environments, from personal computers to large distributed computing systems, traditional virtualization technologies are associated with computational overheads. While these computational overheads have steadily decreased, over the years, and often represent ten percent or less of the total computational bandwidth consumed by an application running above a guest operating system in a virtualized environment, traditional virtualization technologies nonetheless involve computational costs in return for the power and flexibility that they provide.

While a traditional virtualization layer can simulate the hardware interface expected by any of many different operating systems. OSL virtualization essentially provides a secure partition of the execution environment provided by a particular operating system. As one example, OSL virtualization provides a file system to each container, but the file system provided to the container is essentially a view of a partition of the general file system provided by the underlying operating system of the host. In essence. OSL virtualization uses operating-system features, such as namespace isolation, to isolate each container from the other containers running on the same host. In other words, namespace isolation ensures that each application is executed within the execution environment provided by a container to be isolated from applications executing within the execution environments provided by the other containers. A container cannot access files that are not included in the container's namespace and cannot interact with applications running in other containers. As a result, a container can be booted up much faster than a VM, because the container uses operating-system-kernel features that are already available and functioning within the host. Furthermore, the containers share computational bandwidth, memory, network bandwidth, and other computational resources provided by the operating system, without the overhead associated with computational resources allocated to VMs and virtualization layers. Again, however, OSL virtualization does not provide many desirable features of traditional virtualization. As mentioned above. OSL virtualization does not provide a way to run different types of operating systems for different groups of containers within the same host and OSL-virtualization does not provide for live migration of containers between hosts, high-availability functionality, distributed resource scheduling, and other computational functionality provided by traditional virtualization technologies.

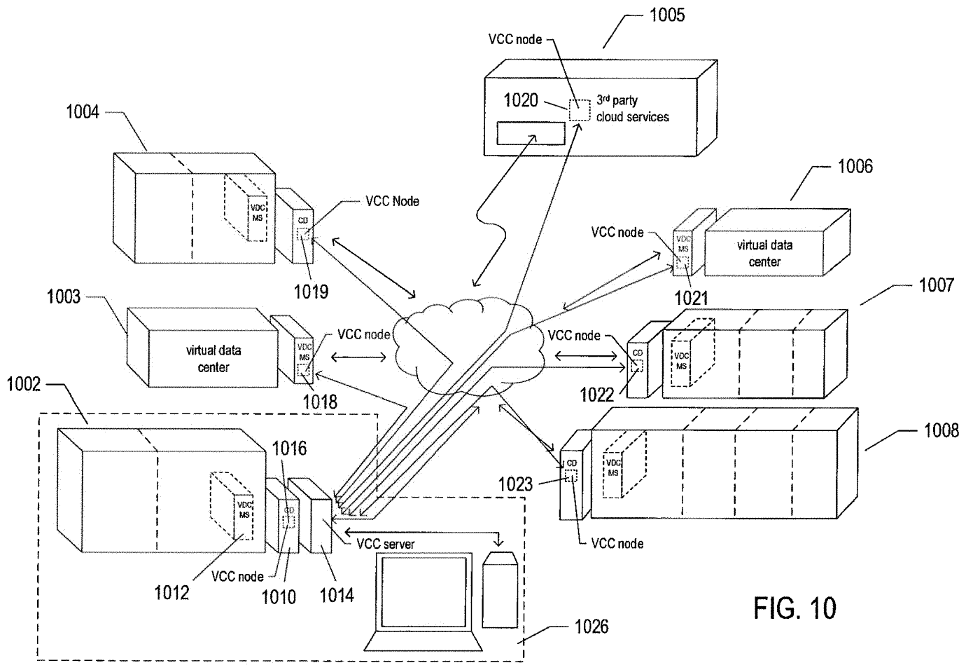

FIG. 11 shows an example server computer used to host three containers. As discussed above with reference to FIG. 4, an operating system layer 404 runs above the hardware 402 of the host computer. The operating system provides an interface, for higher-level computational entities, that includes a system-call interface 428 and the non-privileged instructions, memory addresses, and registers 426 provided by the hardware layer 402. However, unlike in FIG. 4, in which applications run directly above the operating system layer 404. OSL virtualization involves an OSL virtualization layer 1102 that provides operating-system interfaces 1104-1106 to each of the containers 1108-1110. The containers, in turn, provide an execution environment for an application that runs within the execution environment provided by container 1108. The container can be thought of as a partition of the resources generally available to higher-level computational entities through the operating system interface 430.

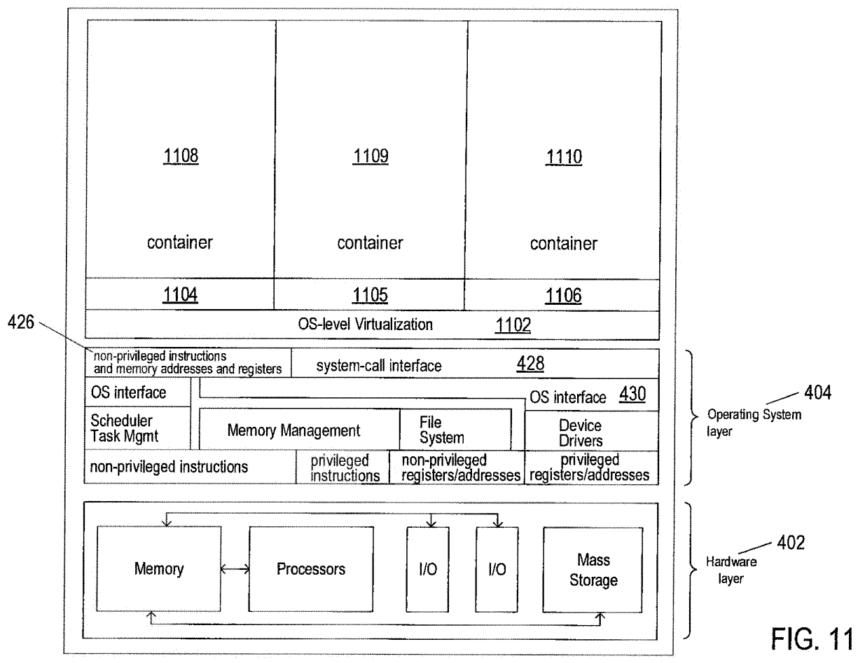

FIG. 12 shows an approach to implementing the containers on a VM. FIG. 12 shows a host computer similar to that shown in FIG. 5A, discussed above. The host computer includes a hardware layer 502 and a virtualization layer 504 that provides a virtual hardware interface to a guest operating system 1102. Unlike in FIG. 5A, the guest operating system interfaces to an OSL-virtualization layer 1104 that provides container execution environments 1206-1208 to multiple application programs.

Note that, although only a single guest operating system and OSL virtualization layer are shown in FIG. 12, a single virtualized host system can run multiple different guest operating systems within multiple VMs, each of which supports one or more OSL-virtualization containers. A virtualized, distributed computing system that uses guest operating systems running within VMs to support OSL-virtualization layers to provide containers for running applications is referred to, in the following discussion, as a “hybrid virtualized distributed computing system.”

Running containers above a guest operating system within a VM provides advantages over traditional virtualization in addition to the advantages of OSL virtualization. Containers can be quickly booted to provide additional execution environments and associated resources for additional application instances. The resources available to the guest operating system are efficiently partitioned among the containers provided by the OSL-virtualization layer 1204 in FIG. 12, because there is almost no additional computational overhead associated with container-based partitioning of computational resources. However, many of the powerful and flexible features of the traditional virtualization technology can be applied to VMs in which containers run above guest operating systems, including live migration from one host to another, various types of high-availability and distributed resource scheduling, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides for flexible and scaling over large numbers of hosts within large distributed computing systems and a simple approach to operating-system upgrades and patches. Thus, the use of OSL virtualization above traditional virtualization in a hybrid virtualized distributed computing system, as shown in FIG. 12, provides many of the advantages of both a traditional virtualization layer and the advantages of OSL virtualization.

### Automated Computer-Implemented Methods for Predicting Behavior of a Distributed Application

A distributed application comprises multiple VMs or containers that run application components simultaneously on one or more host server computers of a distributed computing system. The components are typically executed separately in the VMs or containers. The server computers are networked together so that information processing performed by the distributed application is distributed over the server computers and the VMs or containers can exchange data. The distributed application can be scaled up or down to satisfy changing demands by scaling up or down the number of VMs or containers. As a result, a typical distributed application can process multiple requests from multiple clients at the same time.

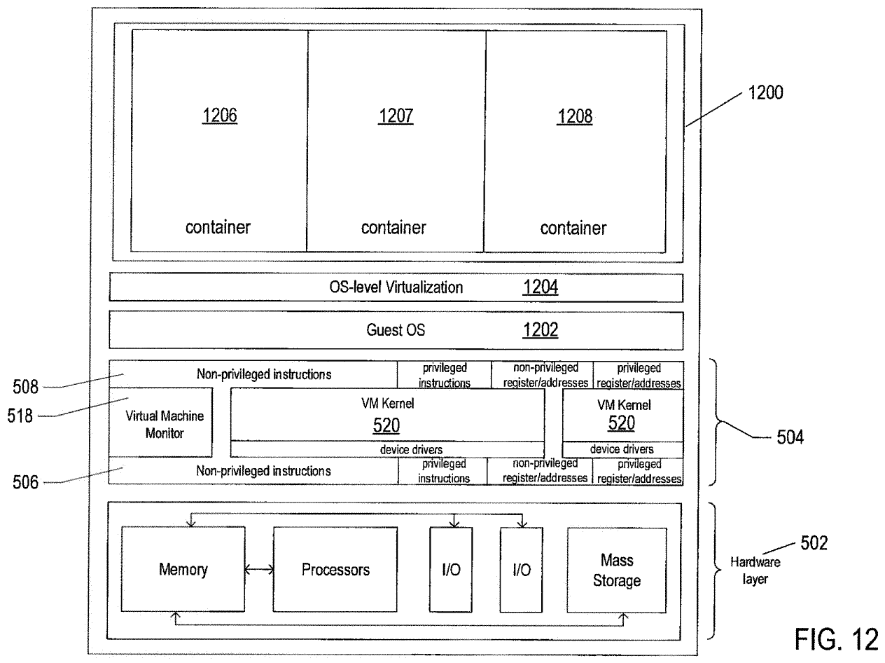

FIG. 13 shows an example of a distributed application that runs in a virtualization layer 1302 that, in turn, runs in a physical data center 1304. For the sake of illustration, the virtualization layer 1302 is shown separated from the physical data center 1304 by a virtual-interface plane 1306. The physical data center 1304 is an example of a distributed computing system. The physical data center 1304 comprises physical objects, including an administration computer system 1308, any of various computers, such as PC 1310, on which a virtual-data-center (“VDC”) management interface may be displayed to system administrators and other users, server computers, such as server computers 1312-1319, data-storage devices, and network devices. Each server computer may have multiple network interface cards (“NICs”) that provide high bandwidth and networking to other server computers and data storage devices in the physical data center 1304. The server computers may be networked together to form server-computer groups within the data center 1304. The example physical data center 1304 includes three server-computer groups, each of which have eight server computers. For example, server-computer group 1320 comprises interconnected server computers 1312-1319 that are connected to a mass-storage array 1322 via a switch (not shown). Within each server-computer group, certain server computers are grouped together to form clusters. Each cluster provides an aggregated set of resources, such as processors, memory, and disk space, (i.e., resource pool) to objects in the virtualization layer 1302. Physical data centers are not limited to the example physical data center 1304. Different physical data centers may include many different types of computers, networks, data-storage systems, and devices connected according to many different types of connection topologies.

The virtualization layer 1302 includes virtual objects, such as VMs, applications, and containers, hosted by the server computers in the physical data center 1304. The virtualization layer 1302 includes datastores 1324 and 1325. The virtualization layer 1302 also includes a virtual network (not illustrated) comprising virtual switches, virtual routers, virtual load balancers, and virtual NICs formed from the physical switches, routers, and NICs of the physical data center 1304. Certain server computers host VMs and containers as described above. For example, cluster of server computers 1326-1328 host six VMs identified as VM₁, VM₂, VM₃, VM₄, VM₅, and VM₆ and cluster of server computers 1312 and 1313 host four VMs identified as VM₇, VM₈, VM₉, VM₁₀. Other server computers may host applications as described above with reference to FIG. 4.

In FIG. 13, the VMs VMₙ, n=1, . . . , 10, contain application components of a distributed application executed on the clusters of server computers 1312-1313 and 1326-1328. The resources of the server computers 1326-1328 form a resource pool for the six VMs VM₁, VM₂, VM₃, VM₄, VM₅, and VM₆. The resources of the server computers 1312 and 1313 form a resource pool for the four VMs VM₇, VM₈, VM₉, and VM₁₀. The VMs enable different software components of the distributed application to run on different operating systems, share the same pool of resources, and share data. The VMs VMₙ, n=1, . . . , 10, may contain software components of a distributed application that enable users to purchase items sold by an owner of the distributed application over the Internet. For example, VM₁ VM₂ and VM₃ may provide frontend services, such as web site and mobile app services, that display products on the web site and mobile app, allow users to enter user information, and complete transactions. VMs VM₄-VM₁₀ execute backend operations that complete each user's purchase, such as collecting money from a user's bank, charging a user's credit card, updating a user's information, updating the owner's inventory, and arranging for products to be shipped to the user.

A distributed computing environment comprises a distributed application and any hardware components of a distributed computing system used to run the distributed application. For example, clusters of server computers 1312-1313 and 1326-1328 and VMs VMₙ, n=1, . . . , 10, form a distributed computing environment. Managing a distributed application involves making changes to the distributed computing environment, such as adding new hosts to a cluster, removing hosts from a cluster, reconfiguring host parameters, such as adding memory, upgrading server software, moving VMs from one host to another, and adding or deleting VMs. Changes to a distributed computing environment are typically implemented to resolve operational issues, such as poor application performance, comply with changes in security policies, plan for future growth, and reclaim wasted resources, such as reclaiming idle CPUs and memory assigned to an idle VM. However, many of these changes may have unintended consequences. For example, running a backup VM may overload a network and/or data storage devices and create contention for resources, such as contention for CPU and memory, which slows the overall performance of a distributed application. Adding a host to a cluster already running a distributed application in VMs may enable CPU bound VMs to perform more input/output operations per second (“IOPS”), but such a change may overload network capacity allocated to the cluster and other VMs may perform worse with the additional host.

Because of the complexity of distributed computing environments. IT administrators and application owners are not able to accurately predict the impact a change to a distributed computing environment may have on performance of a distributed application. A change that adversely impacts performance of a distributed application is costly to roll back, may cut off users from vital services, may damage an application owner's reputation, or drive customers to a competitor's website. As a result, administrators and application owners that have changed a distributed computing environment with a goal of improving performance of a distributed application but instead caused an unintended service outage are typically reluctant or slow to implement important changes to the distributed computing environment in the future.

Automated computer-implemented methods for predicting behavior of a distributed application in response to changes to a distributed computing environment are performed by a management server 1330. The management server 1330 is run in one or more VMs on the administration computer system 1308. System administrators access the management server 1330 via virtual-data-center (“VDC”) management interface, such as graphical user interface, displayed on a PC, such as PC 1310. The management server 1330 enable users, such as system administrators and application owners, to propose a change (i.e., “What-If scenario”) to a distributed computing environment and predict the impact the proposed change is expected to have on performance of the distributed application.

The management server 1330 collects information about a distributed computing environment at different points in time. The information collected at each point in time is used to generate a corresponding graph that models the state of the distributed computing environment. Nodes of the graph represent objects in the distributed computing environment, edges represent relationships between the objects, node labels represent operational data about the object (e.g., configuration, properties, and metrics), and certain node outputs are KPIs of the distributed application. A user proposes a change to the distributed computing environment in the form of a What-if scenario. The management server 1330 outputs predicted KPIs that represent how the distributed application is expected to respond to the What-if scenario. The predicted KPIs can be compared with current KPIs of the distributed application to determine whether the proposed change is benign, beneficial, or detrimental to performance of the distributed application.

The management server 1330 aids administrators and application owners with gaining confidence in executing proposed changes to their distributed computing environment by providing users with accurate predictions of how the distributed application is expected to behave in response to the proposed changes. Such predictions reduce the possibility of making an adverse change to the distributed computing environment, increase the rate at which administrators and application owners make useful changes, and reduces wasted resources. As a result, administrators and application owners are less likely to over-provision or under-provision a distributed computing environment and are more likely to reclaim idle resources.

Data Collection

The management server 1330 collects various types of data about a distributed computing environment at a series of points in time called “time stamps.” The various types of data collected at each time stamp includes

(1) infrastructure inventory of the objects comprising the distributed computing environment, such as clusters, hosts, VMs, network elements, storage elements, applications comprising a distributed application, and other objects in the distributed computing environment;

(2) virtual and physical object configurations, such as number of cores, amount of memory, and disk space:

(3) object relationships, such as how each object is related to one or more other objects in the distributed computing environment (A VM that runs on a host is a relationship between the VM and the host objects. Two or more hosts of a cluster is relationship between the cluster object and each of the hosts objects);

(4) operational metrics of the objects, such as CPU usage, CPU contention, CPU wait time, memory usage, network bandwidth, storage bandwidth, and latency:

(5) application inventory, such as applications running in the VMs, metadata that describes how VMs are organized into a distributed application (e.g., a shopping application may comprise load-balancer VMs, application server VMs, message queue VMs, cache VMs, and database VMs); and

(6) application key performance indicators (“KPIs”) are retrieved from the data-storage device. A KPI is a metric that indicates or represents the performance level of a distributed application. For example, a KPI fir a shopping distributed application could be the number of shopping carts successfully closed per hour. A KPI for a website may be response times to customer requests. Another KPI that may be used to measure the performance level of a distributed application is a distributed resource scheduling (“DRS”) score. A DRS score is a measure of efficient use of resources (e.g., CPU, memory, and network) by object, such as a VM, and is computed as a product of efficiencies as follows:

DRS_score(t)=EFFCY_{CPU}(t)×EFFCY_{Mem}(t)×EFFCY_{Net}(t)

where

$${EFFCY}_{CPU} ( t ) = \frac{CPU usage ( t )}{Ideal CPU usage} ;$$

$${EFFCY}_{Mem} ( t ) = \frac{Memory usage ( t )}{Ideal Memory usage} ; and$$

$${EFFCY}_{Net} ( t ) = \frac{Network throughput ( t )}{Ideal Network throughpu}$$

The metrics CPU usage(t), Memory usage(t), and Network throughput(t) of an object are measured at points in time. Ideal CPU usage, Ideal Memory usage, and Ideal Network throughput are preset. For example, Ideal CPU usage may be preset to 30% of the CPU available to the object and Ideal Memory usage may be preset to 40% of the memory available to the object. DRS™ is a VMware, Inc, technology executed in the management server for automated migration of VMs between hosts in a cluster. DRS uses a scoring mechanism to compute a DRS score, such as the DRS score above, as a measure of efficient use of resources. DRS scores can be used as a KPI that measures the overall health of a distributed application by aggregating, or averaging, the DRS scores of each VM in the distributed application. The DRS score is computed at regular time intervals, such as every 1 minute or every 5 minutes. A large DRS score indicates efficient use of resources by an object, such as efficient use of resources by VM. A small DRS score indicate a less efficient use of resources by a VM.

The management server 1330 uses any of various application programming interfaces (“APIs”) to collect data about a distributed computing environment. For example, the data ma) be collected using APIs in VMware's vCenter®, which is a management utility that manages VMs, hosts, and dependent components from a single centralized location, such the management server 1330. The management server 1330 persists the data in a database.

The management server 1330 receives and records metrics from the objects of distributed computing environment. Each metric is a stream of time series data that may be generated by an operating system, a resource, or by an object itself. A stream of metric data comprises a sequence of time-ordered metric values recorded in spaced points in time called “time stamps” and is denoted by

M=(xⱼ)ⱼ₌₁^{N}=(x(tⱼ))ⱼ₌₁^{N} (1)

where

M represents a metric;

N is the number of metric values in the sequence;

xⱼ=x(tⱼ) is a metric value;

tⱼ is a time stamp indicating when the metric value was recorded in a data-storage device; and

subscript j is a time stamp index j=1, . . . , N.

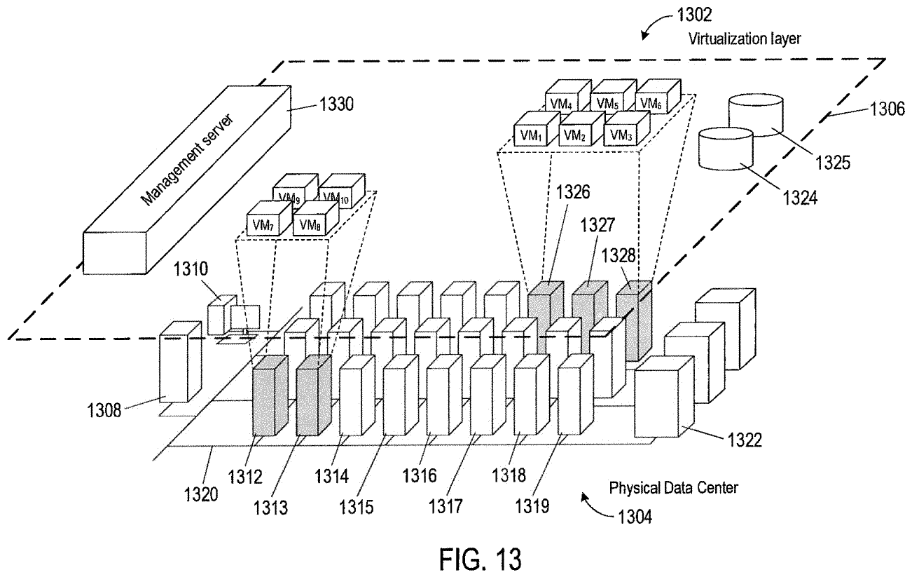

FIG. 14 shows a plot of an example metric. Horizontal axis 1402 represents time. Vertical axis 1404 represents a range of metric value amplitudes. Curve 1406 represents a metric as time series data. In practice, a metric comprises a sequence of discrete metric values in which each metric value is recorded in a data-storage device. FIG. 14 includes a magnified view 1408 of three consecutive metric values represented by points. Each point represents a value of the metric at a time stamp. For example, points 1410-1412 represent consecutive metric values xⱼ₋₁, xⱼ, and xⱼ₊₁ recorded in a data-storage device at corresponding time stamps tⱼ₋₁, tⱼ, and tⱼ₊₁. The metric 1406 may represent usage of a physical or virtual resource. For example, the metric may represent CPU usage of a core in a multicore processor of a server computer over time. The metric may represent the amount of virtual memory used by a VM over time. The metric may represent network throughput for a server computer. The metric may represent network traffic for a server computer. The metric may also represent a KPI, such as CPU contention, response time to requests, number of operations completed per unit time, and wait time for access to an object or an application of a distributed application.

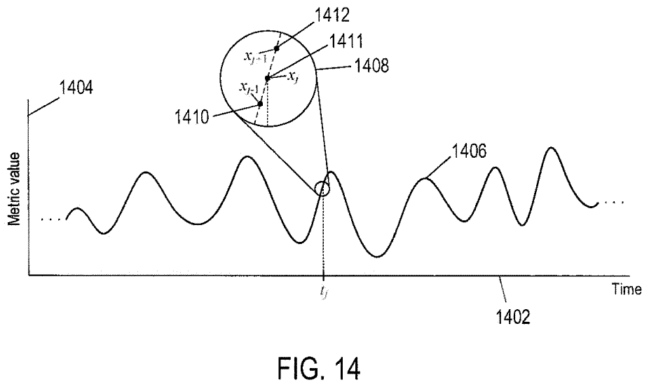

FIG. 15 shows a table of the type of data collected by the management server 1330 for the example distributed application executed with the VMs VMₙ, n=1, . . . , 10, shown in FIG. 13. The management server 1330 persists the data in a data-storage device. Column 1501 lists objects of a distributed computing environment. For example, hosts Host_{A1}, Host_{A2}, and Host_{A3} correspond to server computers 1326-1328 and hosts Host_{B1} and Host_{B2} correspond to server computers 1312 and 1313 in FIG. 13. VMs 1502 are the VMs VMₙ, n=1, . . . , 10, shown in FIG. 13. Applications denoted by App₁, App₂. App₃, and App₄ are software components of an example distributed application and are run in the ten VMs. Column 1503 list features of the clusters, hosts. VMs and applications listed in column 1501. For example, Cores_{A}, Mem_{A}, and DS_{A} represent the total number of cores, total amount of memory, and total disk space, respectively, of the cluster Cluster_{A} and Cores_{A1}, Mem_{A1}, and DS_{A1} represent the total number of cores, total amount of memory, and total disk space, respectively, of the host Host_{M}, Column 1504 list metrics associated with the objects listed in column 1501. The metrics include CPU usage, memory, and IOPS of each object. For example, vCPU₁, vMem₁, and IOPS, represent virtual CPU usage, virtual memory usage, and IOPS, respectively, for VM₁. The metrics may also include CPU wait time, latency, storage bandwidth, response time to client requests, and network bandwidth. Column 1506 list relationships between the objects. For example, host Host_{A1} is member of cluster Cluster_{A}.

Graph Generation

The management server 1330 uses the objects and relationships between objects of a distributed computing environment to construct a corresponding graph. The graph is a model representation of the distributed computing environment and is represented by

G=(N,E) (2)

where

N={n₁, . . . , n_{d}} is a set of nodes and subscript d is the number of nodes in the graph (i.e., number of objects in the distributed computing environment); and

E is a set of edges, such that e_{(α,β)}∈E denotes an edge connecting nodes n_{α} and n_{β}.

A node nᵢ in the set of nodes N represents a physical object or a virtual object of the distributed computing environment. An edge e_{(α,β)} in the set of edges \tilde{E} represents a relationship, or connection, between two nodes n_{α} and n_{β} at the time stamp tⱼ.

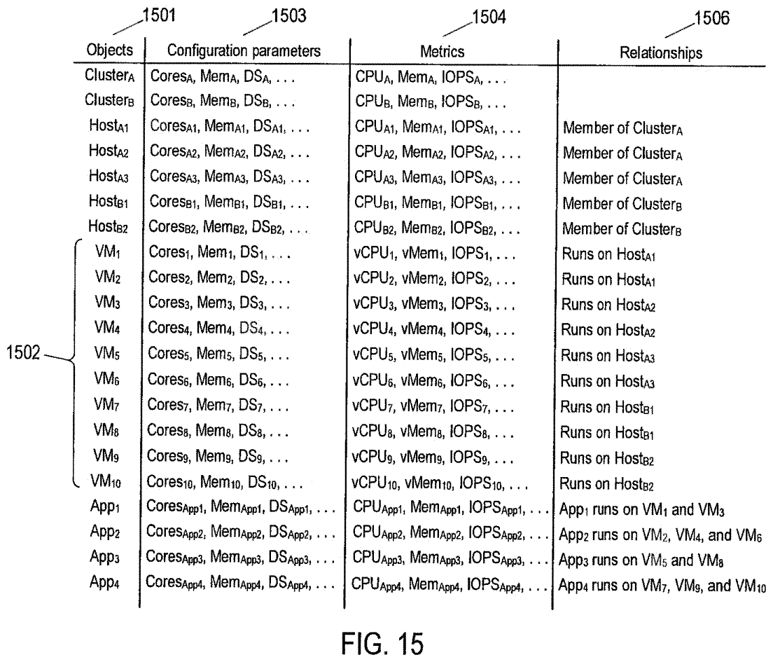

FIG. 16 shows an example graph 1600 comprising five nodes (i.e., d=5) and seven edges. Each node represents an object of a distributed computing environment. Edges represent a relationship between nodes. For example, node n₁ is connected to nodes n₂, n₃, n₄, and n₅ as represented by edges e_{(1,2)}, e_{(1,3)}, e_{(1,4)}, and e_{(1,5)}. Node n₁ may represent, for example, a server computer and nodes n₂, n₃, n₄, and n₅ may represent four VMs that run on the node n₁.

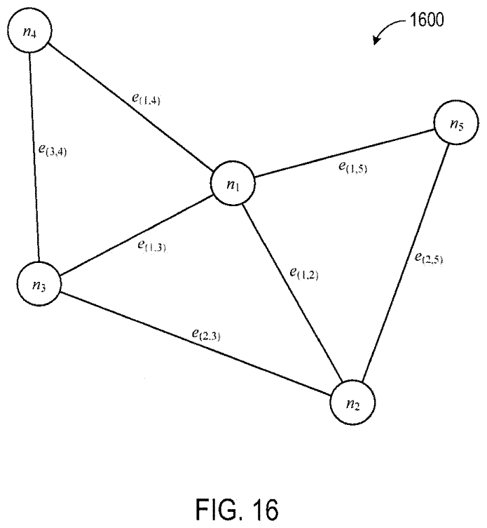

FIG. 17 shows an example of a graph 1700 of the distributed computing environment of the objects and relationships described above with reference to FIG. 15. The graph 1700 has a root node 1702 that represents the data center. The objects listed in column 1501 of FIG. 15 are the nodes of the graph 1700. For example. Cluster- and Cluster₂ are represented by nodes 1704 and 1706, respectively. Edges represent the relationships listed in column 1506 of FIG. 15. For example, edges 1708, 1709, and 1710 represent Host_{A1}, Host_{A2}, and Host_{A3}, respectively, are members of Cluster_{A}. Each node has associated configuration and metric information, which are the features of the objects that are maintained by the management server 1330. For example. Host_{A1} has associated configuration and metric information 1712, VM₁ has associated configuration and metric information 1714, and App₁ has associated configuration and metric information 1716.

Graph Partition

Certain objects of a distributed computing environment influence one another while other objects have only marginal or no influence on other objects of the distributed computing environment. In terms of the graph representation of the distributed computing environment, a node of the graph can influence another node of the graph even though the two nodes are not directly connected by an edge. For example, with reference to FIG. 17. VM₁ on Host_{A1} might influence VM₃ on Host_{A2} if Host_{A1} and Host_{A2} share underlying physical infrastructure, such as sharing the same data storage appliance or sharing the same network. In practice, many pairs of objects of a distributed computing environment do not interfere with one another because the objects do not share the same physical resources or the effect the objects have on one another is so weak that the interactions are dominated by noise and other effects that for practical purposes can be ignored. For example, suppose Host_{A1} and Host_{A2} share the same power supply and that VM₁ is using much of the CPU of Host_{A1}, which causes Host_{A1} to consume more power than Host_{A2}. As a result, Host_{A2} slows which impacts the performance of VM₃.

The management server 1330 partitions a graph into S subgraphs denoted by SGₖ, where S is the number of subgraphs and k=1, . . . , S, based on a user-selected rule. Each subgraph is a model of a different subsystem of objects of the distributed computing environment. The management server 1330 executes one of many different rules selected by a user for partitioning the graph of the distributed computing environment into two or more subgraphs. Each rule corresponds to a different set of regulations for partitioning the graph into subgraphs and ensures that influences between objects represented by nodes within each subgraph are reasonably strong but influences between nodes of different subgraphs are negligible.

In one implementation, the management server 1330 partitions a graph based on a rule that places objects that influence the performance of one another in the same subgraph. For each pair of objects of the distributed computing environment, the management server 1330 determines pairs of objects that influence one another by computing a correlation coefficient between different combinations of metrics of the two objects. If a correlation between metrics of two objects is detected, then the objects are considered to have some degree of influence on one another. The larger the number of pairs of correlated metrics two objects have, the greater the likelihood the objects influence one another. A user may set a minimum number of metrics that must be correlated to declare that any two objects influence one another and are placed in the same subgraph.

Metrics collected by the management server 1330 are typically not synchronized to the same time stamps. For example, metric values of a metric may be generated by a metric source at periodic intervals, but the periodic intervals may vary between time stamps. On the other hand, metric values of another metric may be generated at nonperiodic intervals and are not synchronized with the time stamps of other metrics. In certain cases, the management server 1330 may request metric data from objects at regular intervals while in other cases, the objects may actively send metric data to the management server 1330 at periodic intervals or whenever metric data becomes available.

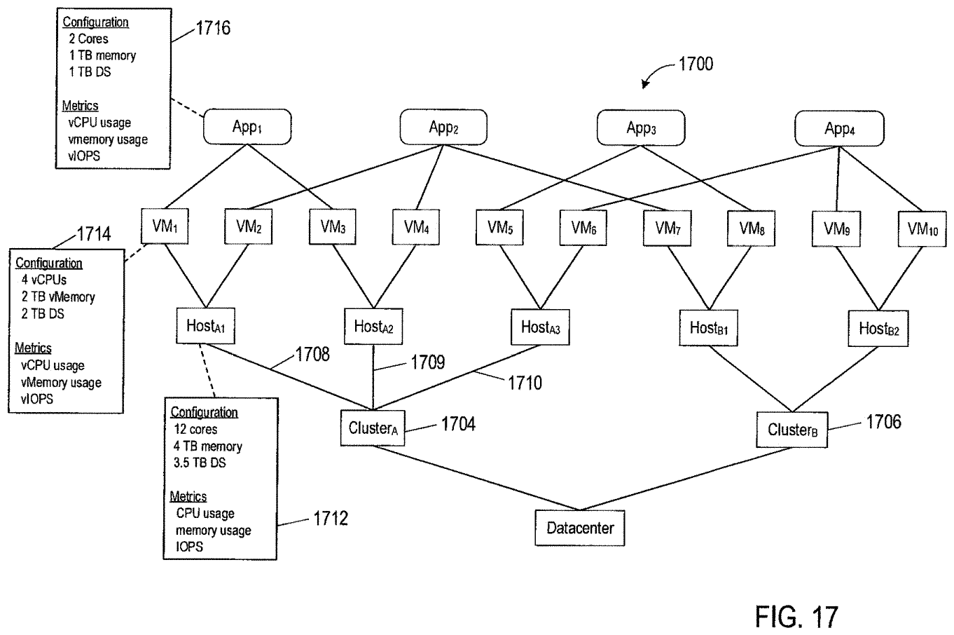

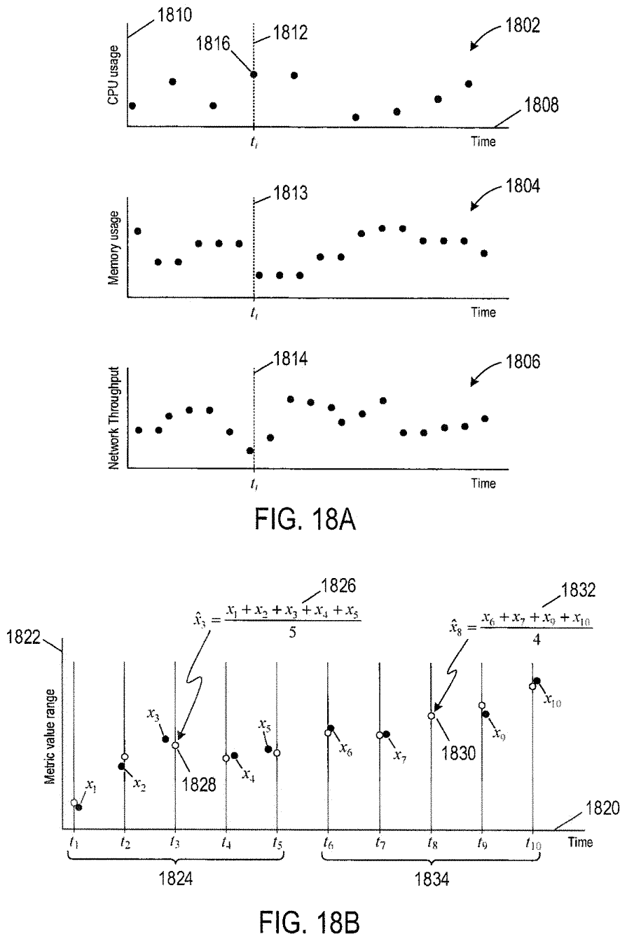

FIG. 18A shows plots of three examples of unsynchronized metrics for CPU usage 1802, memory usage 1803, and network throughput 1806 recorded in the same time interval. Horizontal axes, such as horizontal axis 1808, represent the length of the time interval. Vertical axes, such as vertical axis 1810, represent ranges of metric values for the CPU, memory, and network throughput. Dots represent metric values recorded at different time stamps in the time interval. CPU metric values are recorded at different periodic intervals than the memory and network throughput metric values. Dashed lines 1812-1814 mark the same time stamp, tⱼ, in the time interval. A metric value 1816 represents CPU usage recorded at time stamp tⱼ. However, memory usage and network throughput metrics do not have metric values recorded at the time stamp tⱼ. As a result, the CPU usage, memory usage, and network throughput are not synchronized.

The management server 1330 synchronizes the metrics to a general set of uniformly spaced time stamps, such as by computing a run-time average of metric values in a sliding time window centered at each time stamp of the general set of uniformly spaced time stamps. In an alternative implementation, the metric values with time stamps in the sliding time window may be smoothed by computing a run-time median of metric values in the sliding time window centered at each time stamp of the general set of uniformly spaced time stamps. The management server 1330 may also synchronize the metrics by deleting time stamps of missing metric values and/or interpolating missing metric data at time stamps of the general set of uniformly spaced time stamps using a running average, linear interpolation, quadratic interpolation, or spline interpolation.

FIG. 18B shows a plot of metric values synchronized to a general set of uniformly spaced time stamps. Horizontal axis 1820 represents time. Vertical axis 1822 represents a range of metric values. Solid dots represent metric values recorded at irregularly spaced time stamps. Marks located along time axis 1820 represent time stamps of a general set of uniformly spaced time stamps. Note that the metric values are not aligned with the time stamps of the general set of uniformly spaced time stamps. Open dots represent metric values aligned with the time stamps of the general set of uniformly spaced time stamps. Bracket 1824 represents a sliding time window centered at a time stamp t₃ of the general set. The metric values x₁, x₂, x₃, x₄, and x₅ have time stamps within the sliding time window 1824 and are averaged 1826 to obtain synchronized metric value 1828 at the time stamp t₃ of the general set of uniformly spaced time stamps. A synchronized metric value 1830 is interpolated for a missing metric value at the time stamp is by computing an average 1832 of the metric values in the time window 1834.

The management server 1330 computes a correlation coefficient between pairs of metrics of two different objects of the distributed computing environment. Let Mₘⁱ denote a m-th metric of an i-th object of a distributed computing environment. Let Mₚ^{q} denote an q-th metric of a p-th object of the distributed computing environment. The metrics Mₘⁱ and Mₚ^{q} are time synchronized and denoted by:

Mₘⁱ=(\hat{x}ⱼₘⁱ)ⱼ₌₁^{N} (3a)

Mₚ^{q}=(\hat{x}ⱼₚ^{q})ⱼ₌₁^{N} (3b)

where the hat “\hat{ }” denotes time synchronized metric values.

The management server 1330 computes a correlation coefficient given by:

$$C ( {M}_{m}^{i} , {M}_{p}^{q} ) = \frac{{Σ}_{j = 1}^{N} ( {\hat{x}}_{j m}^{i} - {\overline{x}}_{m}^{i} ) ( {\hat{x}}_{j p}^{q} - {\overline{x}}_{p}^{q} )}{\sqrt{{{Σ}_{j = 1}^{N} ( {\hat{x}}_{jk}^{i} - {\overline{x}}_{m}^{i} )}^{2}} \sqrt{{{Σ}_{j = 1}^{N} ( {\hat{x}}_{j p}^{q} - {\overline{x}}_{ρ}^{q} )}^{2}}} \qquad ( 4 )$$

where

$${\overline{x}}_{m}^{i} = \frac{1}{N} {\sum }_{j = 1}^{N} {\hat{x}}_{j m}^{i}$$

$${\overline{x}}_{p}^{q} = \frac{1}{N} {\sum }_{j = 1}^{N} {\hat{x}}_{j p}^{q}$$

The metrics Mₘⁱ and Mₚ^{q} are correlated when the correlation coefficient satisfies the following condition

C(Mₘⁱ,Mₚ^{q})>Th_{corr} (5)

where Th_{corr} is a correlation threshold (e.g., Th_{corr}=0.70, 0.75, or 0.80).

The number of different combinations of correlation coefficients computed for the i-th object and the q-th object is K×P, where K is the number of metrics associated with the i-th object and P is the number of metrics associated with the q-th object. Two objects are identified as influencing one another and are placed in the same subgraph when the following condition is satisfied:

N(Oᵢ,O_{q})>Thₘᵢₙ (6)

where

N(Oᵢ, O_{q}) is the number of pairs of metrics of the objects Oᵢ and O_{q} that satisfy the condition in Equation (5); and

Thₘᵢₙ is a threshold minimum number of pairs of metrics.

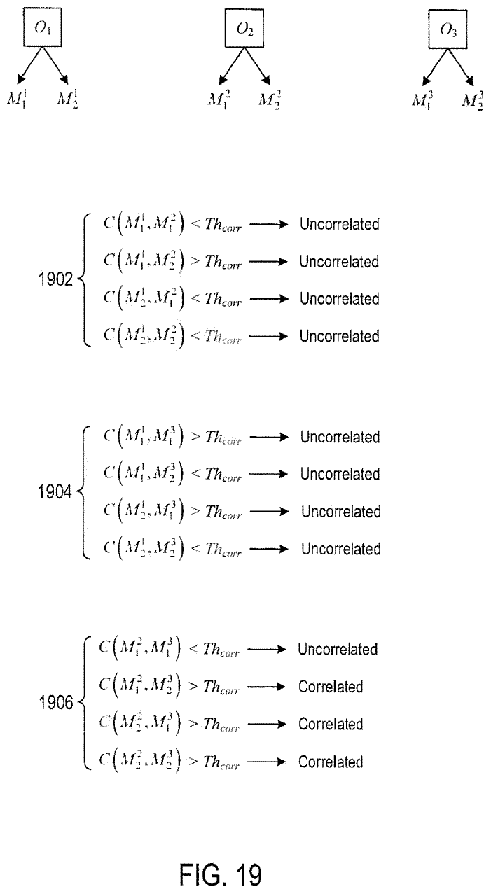

FIG. 19 shows an example of determining pairs of objects that influence one another. The objects are denoted by O₁, O₂, and O₃. The objects may be VMs or the objects may be hosts. For the sake of simplicity, only two metrics of the objects are used to identify objects that influence one another. The metrics M₁¹ and M₂¹ are associated with the object O₁, metrics M₁² and M₂² are associated with the object O₂, and metrics M₁³ and M₂³ are associated with the object O₃. As a result, there are four different combinations of metrics computed for each pair of objects. The metrics associated with an object may, for example, represent CPU usage, memory usage, network usage, latency, or response time. For example, the metric M₁¹ may represent CPU usage by the object O₁ and the metric M₂¹ may represent response time of the object O₁ to client requests. FIG. 19 shows example correlation coefficients and comparisons with a correlation threshold that is used to identify each pair as correlated or uncorrelated. In this example, pairs of objects are identified as influencing one another when the number of correlated pairs of metrics is greater than two (i.e., Thₘᵢₙ=2). Correlation coefficients 1902 are computed for different combinations of the metrics M₁¹ and M₂¹ with the metrics M₁² and M₂² with only one correlation coefficient that satisfies the condition in Equation (5). As a result, the objects O₁ and O₂ do not influence one another. Correlation coefficients 1904 are computed for different combinations of the metrics M₁¹ and M₂¹ with the metrics M₁³ and M₂³ with two correlation coefficients that satisfies the condition in Equation (5). As a result, the objects O₁ and O₃ do not influence one another. On the other hand, correlation coefficients 1906 are computed for different combinations of the metrics M₁² and M₂² with the metrics M₁³ and M₂³ with three correlation coefficient that satisfy the condition in Equation (5). As a result, the objects O₁ and O₃ are identified as influencing one another. Objects that influence one another are placed in the same subgraph. Objects that do not influence another are placed in different subgraphs.

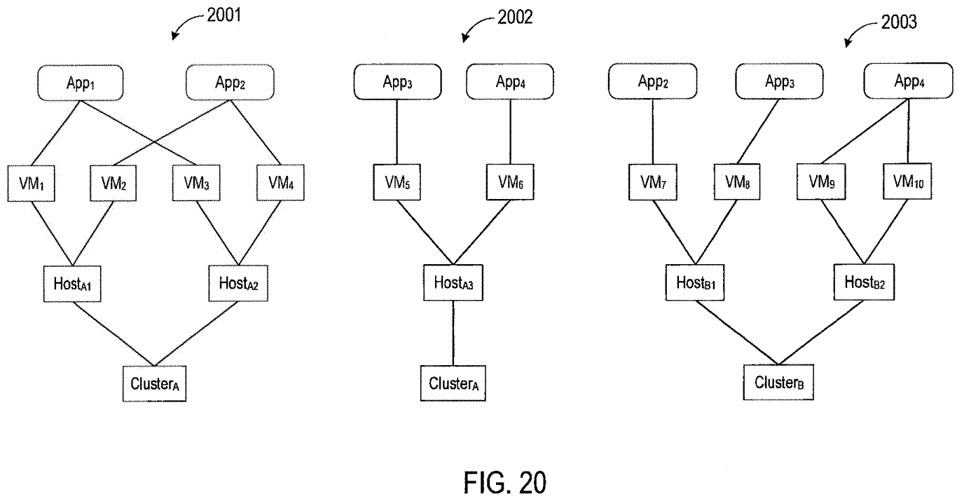

FIG. 20 shows an example partition of the graph 1700 into three subgraphs 2001, 2002, and 2003 based on objects that influence one another. Subgraph 2001 is denoted by SG₁ and contains objects that influence one another but have marginal or no influence on the objects in the subgraphs 2002 and 2003. Subgraph 2002 is denoted by SG₂ and objects that influence one another but have marginal or no influence on the objects in the subgraphs 2001 and 2003. Subgraph 2003 is denoted by SG₃ and contains objects that influence one another but have marginal or no influence on the objects in the subgraphs 2001 and 2002. Each of the subgraphs 2001-2003 represents a different subsystem of objects of the distributed computing environment.

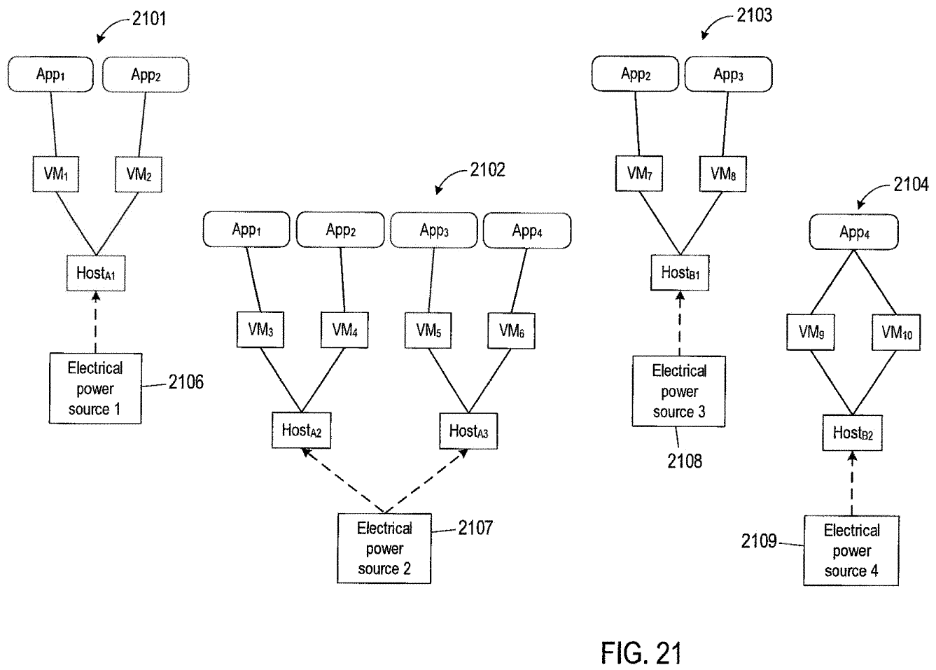

In another implementation, the management server 1330 partitions a graph into subgraphs based on a rule that places objects that receive electrical power from the same power source in the same subgraph. FIG. 21 shows an example of the graph 1700 partitioned into four subgraphs 2101-2104 based on hosts that receive electrical power from four different electrical power sources 2106-2109, respectively. Subgraph 2101 is denoted by SG₁ and contains objects that receive electrical power from power source 1 2106. Subgraph 2102 is denoted by SG₂ and contains objects that receive electrical power from power source 2 2107. Subgraph 2103 is denoted by SG₃ and contains objects that receive electrical power from power source 3 2108. Subgraph 2104 is denoted by SG₄ and contains objects that receive electrical power from power source 4 2109. Each of the subgraphs 2101-2104 represents a different subsystem of objects of the distributed computing environment.

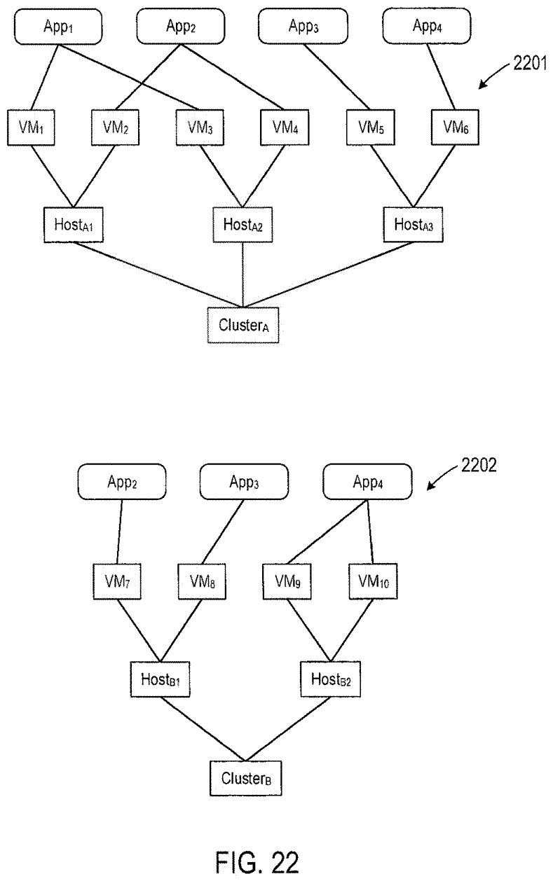

In another implementation, the management server 1330 partitions a graph into subgraphs based on clusters of hosts. FIG. 22 shows an example of the graph 1700 partitioned into two subgraphs 2201 and 2202. Subgraph 2201 is denoted by SG₁ and is formed from the objects in Cluster_{A}. Subgraph 2202 is denoted by SG₂ and is formed from the objects in Cluster_{B}. In the follow description, automated computer-implemented processes of predicting behavior of a distributed application are described with reference to the subgraphs 2201 and 2202. Each of the subgraphs 2201 and 2202 represents a different subsystem of objects of the distributed computing environment.

Simplify Subgraphs into Flattened Subgraphs

The management server 1330 simplifies the subgraphs SGₖ into corresponding flattened subgraphs denoted by FSGₖ, where k=1, . . . , S. Each flattened subgraph has a root node that represents aggregated features of the hosts of the cluster and nodes that represent aggregated features of application components and associated VMs of the subgraph. The nodes of a flattened subgraph are called “fragments” and the fragments correspond to application components and associated VMs.

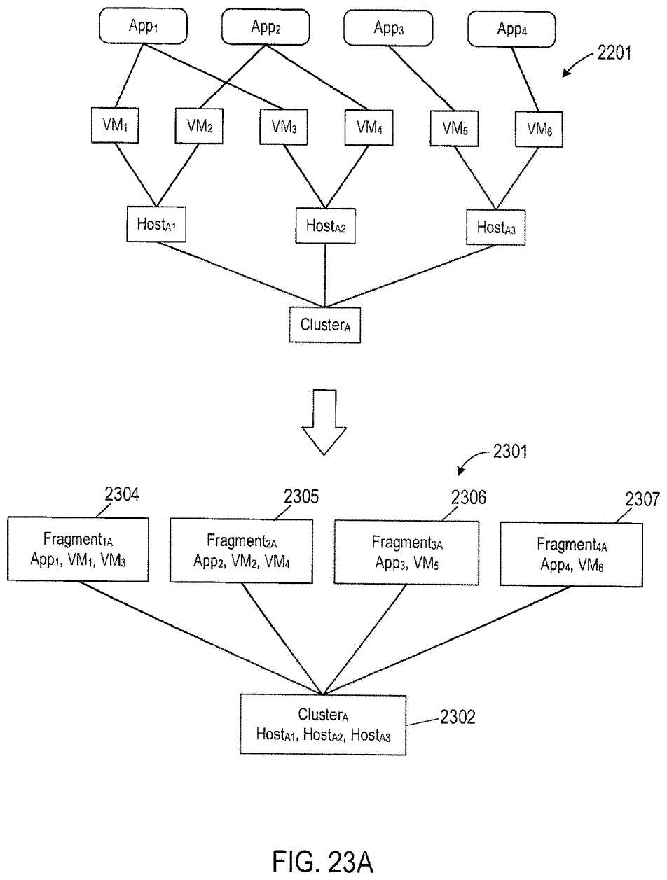

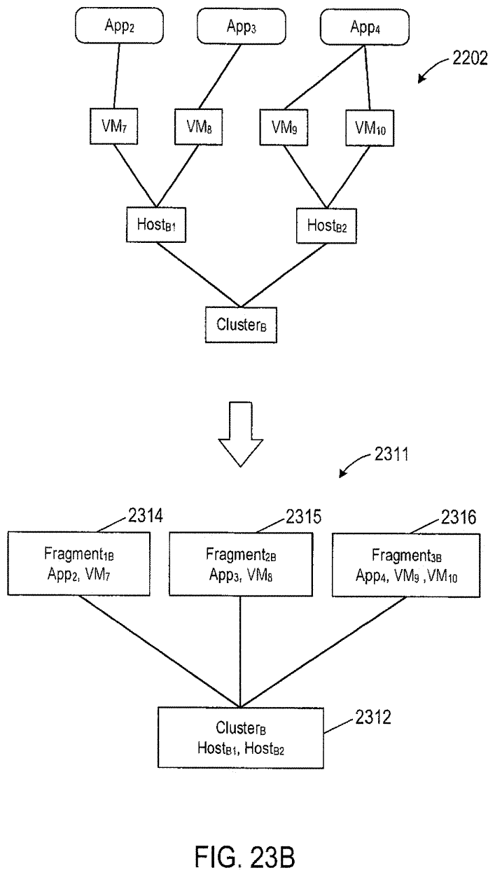

FIG. 23A shows an example of a flattened subgraph 2301 formed from the nodes of the subgraph 2201. The flattened subgraph 2301 is denoted by FSG₁. A root node 2302 represents aggregated features of the Host_{A1}, Host_{A2}, and Host_{A3} in the subgraph 2201. Fragments, represented by nodes 2304-2307, contain aggregated features of the application components App₁, App₂, App₃, and App₄ and corresponding VMs of the subgraph 2201. For example, node 2304 represents a fragment denoted by Fragment_{1A}, where subscript 1 is a fragment index and subscript A is cluster index that corresponds to Cluster_{A}, that contains aggregated features of VM₁ and VM₃ used to run App₁. FIG. 23B shows an example of a flattened subgraph 2311 formed from the nodes of the subgraph 2202. The flattened subgraph 2301 is denoted by FSG₂. A root node 2312 represents aggregated features of the Host_{B1} and HostB₃ in the subgraph 2202. Fragments, represented by nodes 2314-2316, contain aggregated features of the application components App₂, App₃, and App₄ and corresponding VMs of the subgraph 2202. For example, node 2315 represents a fragment denoted by Fragment_{2B} that contains features VM₈ used to run App₁.

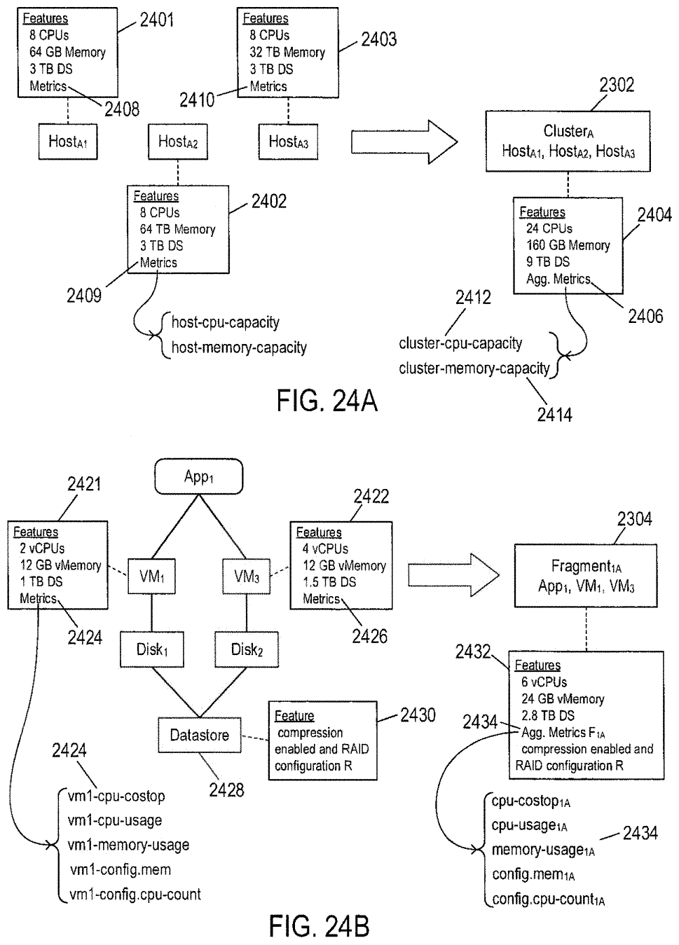

FIGS. 24A-24B show examples of forming fragments represented by nodes in the flattened graph 2201. In FIG. 24A, Host_{A1} has features 2401. Host_{A2} has features 2402, and Host_{A3} has features 2403. The features 2401-2403 of the Host_{A1}, Host_{A2}, and Host_{A3}, respectively, are aggregated to give aggregated host features 2404 represented by root node 2302. The features include number of CPUs, amount of memory, amount of data storage, and the metrics. The metrics 2406 of the node 2302 are formed by aggregating metrics 2408-2410 of the hosts. For example, aggregated metric cluster-cpu-capacity 2412 is obtained by averaging, or summing, host-cpu-capacities of the metrics 2408-2410. A host-cpu-capacity metric is the amount of cpu-capacity remaining. For example, if CPU usage is at 40%, the cpu-capacity remaining is 60%. Similarly, aggregated metric cluster-memory-capacity 2414 is obtained by averaging host-memory-capacities of the metrics 2408-2410. A host-memory-capacity metric is the amount of memory capacity remaining. For example, if run-time memory usage is at 64%, the memory capacity remaining is 36%.

In FIG. 24B, VM₁ has features 2421 and VM₃ has features 2422. The features 2421 and 2422 of VM₁ and VM₃, respectively, are aggregated to give Fragment₁ represented by node 2304. The features 2421 and 2422 include number of virtual CPUs, amount of virtual memory, and amount of data storage. The features 2421 and 2422 include metrics 2424 and 2426 associated with the VMs. For example, the metrics 2424 of VM₁ comprise vm1-cpu-costop, vm1-epu-usage, vm1-memory-usage, vm1-config.mem, and vm1-config.cpu-count. The metric vm1-cpu-costop is the percentage of time the VM₁ is ready to run but is unable to because of co-scheduling constraints. The metric vm1-cpu-usage is the percentage of CPU used by VM₁ out of all the CPU allocated to the VM₁. The metric vm1-memory-usage is the amount of memory VM₁ uses. The metric vm1-config.mem is the amount of memory allocated to VM₁. The metric vm1-config.cpu-count is the number of CPU cores used by VM₁. A model of each VM is maintained by the management server 1330. The model includes details about the disks associated with each VM. For example, VM₁ is associated with Disk₁ and VM₃ is associated with Disk₂. In this example. Disk1 and Disk2 are on a Datastore 2428, which has a compression enabled RAID configuration R 2430. The management server 1330 forms Fragment₁ 2304 by aggregating the features 2421 and 2422 and the features 2430. In this example, the Fragment₁ 2304 contains the features 2432. The metrics of the features 2421 and 2422 are aggregated to form fragment metrics 2434 by averaging, or summing, corresponding metrics 2424 and metrics 2426.

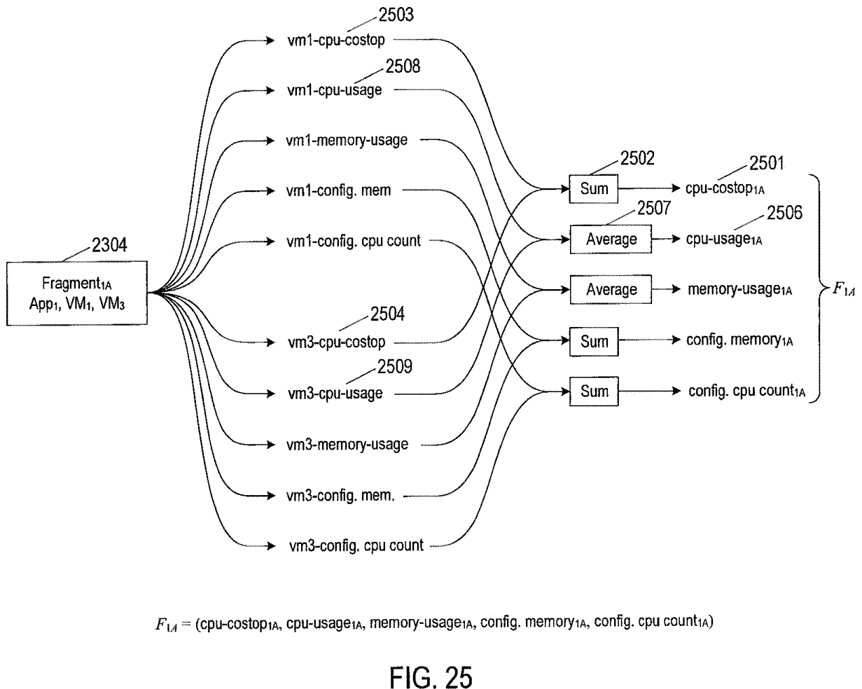

FIG. 25 shows an example of aggregating the metrics 2424 and 2426 of VM₁ and VM₃, respectively, to obtain corresponding fragment metrics 2434 for the Fragment_{1A}. In the example of FIG. 25, the cpu costop, configuration memory, and configuration cpu count of the VMs are summed to obtain corresponding fragment metrics, and cpu usage and memory usage metrics of the VMs are averaged to obtain corresponding fragment metrics. For example, a fragment metric cpu-costop_{1A} 2501 is computed by summing 2502 the metric vm1-cpu-costop 2503 and vm3-cpu-costop 2504. A fragment metric cpu-usage_{1A} 2506 is computed by averaging 2507 the metric vm1-cpu-usage 2508 and the metric vm3-cpu-usage 2509. The fragment metrics of the Fragment_{1A} 2304 are denoted by F_{1A}.

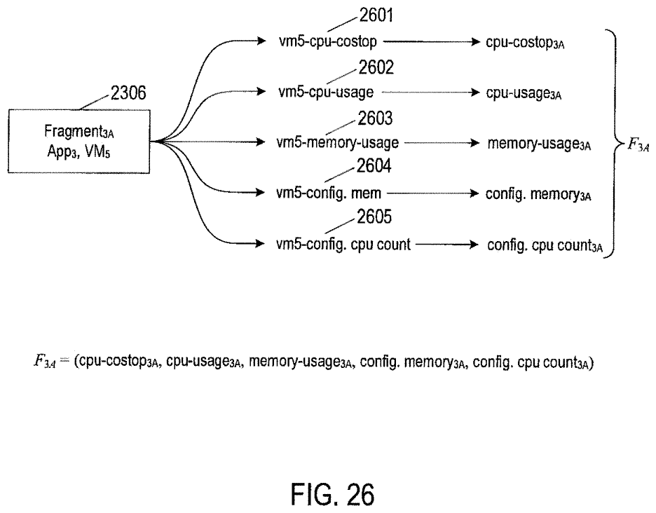

Returning to FIG. 23A. App₃ of Fragment_{3A} 2306 and App₄ of Fragment_{4A} 2307 are each run in only one VM. As a result, metrics of VM₅ are fragment metrics of the Fragment_{3A} 2306 and metrics of VM₆ are fragment metrics of the Fragment_{4A} 2307. FIG. 26 shows an example of metrics 2601-2605 of VM₅ are fragment metrics of Fragment_{3A} 2306. The fragment metrics of the Fragment_{3A} 2306 are denoted by F_{3A}.

Candidate Flattened Subgraphs

A user, such as an administrator or application owner, would like to know in advance of making a change to a distributed computing environment of a distributed application how a change w % ill impact performance of the distributed applications running in the environment. The user proposes a “What if scenario” that corresponds to a change in a distributed computing environment. An example of a proposed change is adding an application component denoted by App_{X} to the distributed computing environment. Another example of a proposed change is adding a host denoted by Host_{X} to the distributed computing environment. In still another example, a user may want to change how resources are allocated to VMs or change configuration of a host. The management server 1330 treats any proposed change as corresponding to a change in each of the fragment subgraphs of the distributed computing environment. The management server 1330 trains two neural networks (‘NNs’) for each flattened subgraph based on the features of the flattened subgraph and features of an object considered for addition to the flattened subgraph. For each subgraph, the management server 1330 trains one of the NNs to compute predicted KPIs of each application component of the distributed application and trains the other NN to compute a predicted KPI of the object considered for addition to the distributed computing environment. The management server 1330 automatically determines whether the object is suitable for addition to the distributed computing environment based on the KPIs. If the object is suitable for addition to the distributed computing environment, the management server 1330 automatically incorporates the object into the distributed computing environment cluster based on which subgraph has favorable KPIs.

The management server 1330 forms a candidate flattened subgraph denoted by CFSGₖ for each flattened subgraph FSGₖ, where k=1, . . . , S. Consider, for example, a user would like to know in advance how adding an App_{X} to the example distributed computing environment represented by the graph 1700 will affect the distributed application. Suppose the App_{X} is expected to run in two VMs denoted by VM_{1X} and VM_{2X}. The management server 1330 constructs a candidate fragment for the application App_{X}, denoted by Fragment_{X}, from the configurations and metrics of VM_{1X}, and VM_{2X} as described above with reference to FIG. 24B. For each flattened subgraph of the graph of the distributed computing environment, the management server 1330 adds a node that corresponds to candidate fragment, Fragments, to the flattened subgraph to form a candidate flattened subgraph.

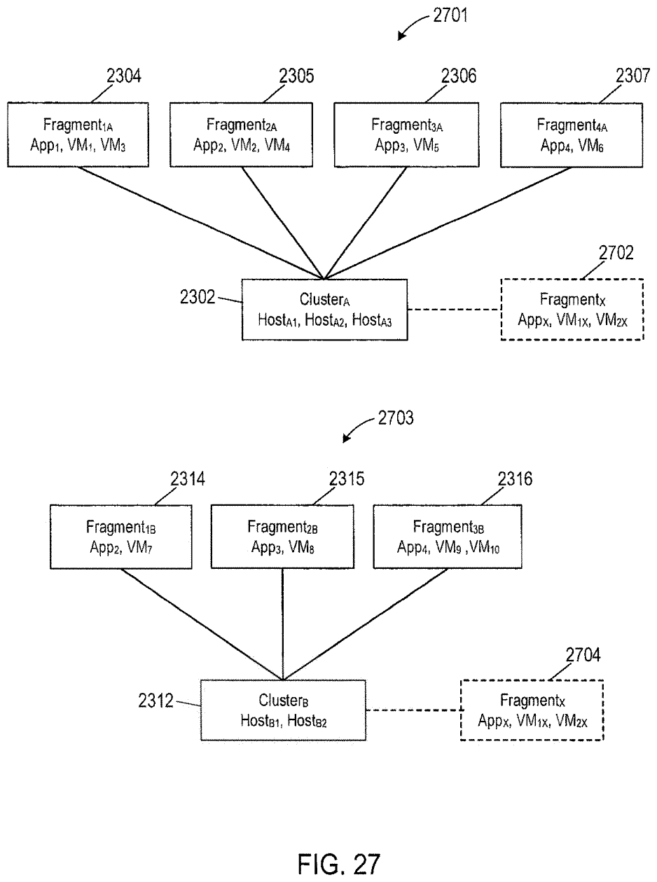

FIG. 27 shows an example candidate flattened subgraph 2701 denoted by CFSG₁ formed from adding candidate fragment. Fragment_{X}, to the flattened subgraphs 2301 in FIG. 23. A node 2702 represents aggregated features of VM_{1X} and VM_{2X}. FIG. 27 also shows an example candidate flattened subgraph 2703 denoted by CFSG₂ formed from adding Fragment_{X} to the flattened subgraphs 2311 in FIG. 23. A node 2704 represents the same aggregated features of VM_{1X} and VM_{2X} as represented by node 2702.

Neural Network

The management server 1330 trains two NN models for each candidate flattened subgraph. Training a NN is a computational machine learning process. A resulting NN can be used to model complex relationships between an input layer of values denoted by [symbol] and an output layer of values denoted by [symbol] . The input layer [symbol] is composed of the values represented by a column vector:

$$\vec{Q} = [ \begin{matrix}\begin{matrix}\begin{matrix}\begin{matrix}{q}_{1} \\ {q}_{2}\end{matrix} \\ {q}_{3}\end{matrix} \\ ⋮\end{matrix} \\ {q}_{M}\end{matrix} ] \qquad ( 7 )$$

where

qⱼ represents the j-th value; and

M is the number of values.

The output layer [symbol] is composed of values represented by a column vector:

$$\vec{R} = [ \begin{matrix}\begin{matrix}\begin{matrix}\begin{matrix}{r}_{1} \\ {r}_{2}\end{matrix} \\ {r}_{3}\end{matrix} \\ ⋮\end{matrix} \\ {r}_{K}\end{matrix} ] \qquad ( 8 )$$

where

rᵢ represents the i-th output value; and

K represents the number of outputs.

The management server 1330 automatically trains a neural network model for each flattened subgraph by adjusting numerical weights in the network of the neural network until the network-action computing performance is acceptable.

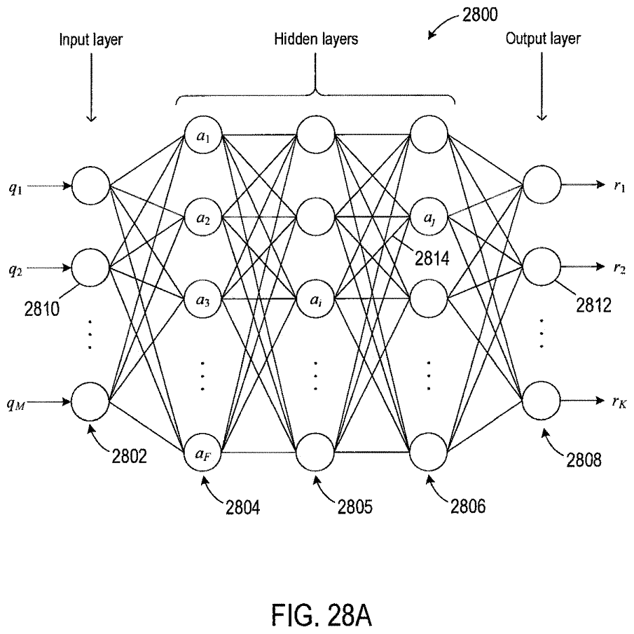

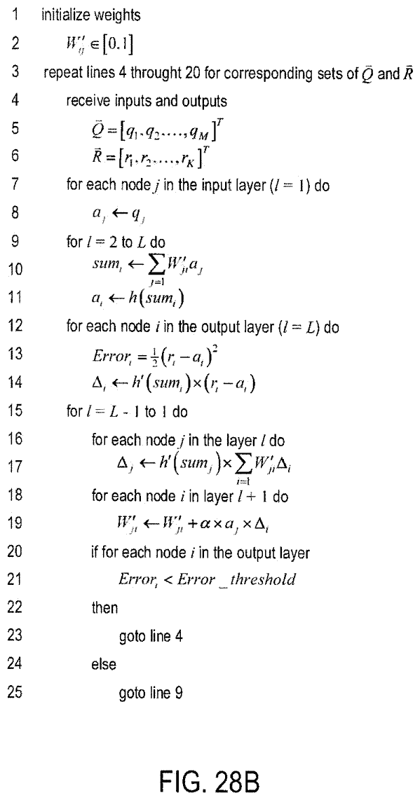

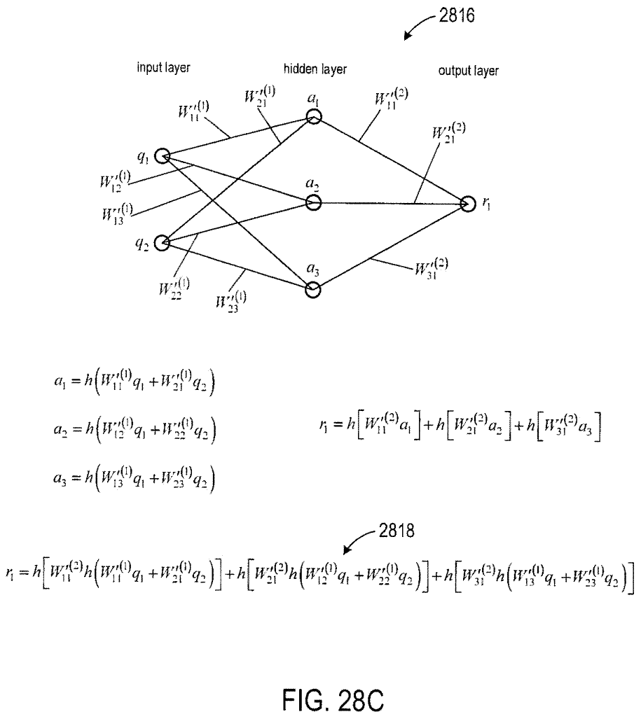

FIG. 28A shows a graph representation of an example neural network 2800 for determining a relationship between an output layer [symbol] and in input layer [symbol] . The neural network 2800 includes an input layer 2802, three hidden layers 2804-2806, and an output layer 2808. The input layer 2802 comprises nodes, such as node 2810, that correspond to values of [symbol] , and the output layer 2808 comprises nodes, such as node 2812 that correspond to values of [symbol] . Hidden layers 2804-2806 comprise nodes that represent hidden units denoted by aᵢ. For example, hidden layer 2804 comprises F nodes that correspond to F hidden units denoted by a₁, a₂, a₃, and a_{F}. Certain pairs of nodes are connected by edges that represent weights. For example, edge 2814 represents a weight denoted by W′ᵢⱼ. Each weight determines the strength of a connection between a pair of nodes. It should be noted that neural networks are not limited to three hidden layers and a fixed number of nodes in each layer. The number of hidden layers and number of nodes in each hidden layer can be selected based on computation efficiency.

FIG. 28B presents an example of a pseudo-code for multilayer feed-forward neural networks that execute learning through back propagation. The number of layers in the neural network is denoted by a positive integer L. It should be noted that this pseudo-code is not intended to limit the number of steps or to be exhaustive of the numerous ways in which a multilayer feed-forward neural networks can be implemented but is instead provided as one example of a computation approach to computing the relationship between an input layer and an output layer. In line 1, the weights W′ᵢⱼ are initialized to values between 0 and 1. The weights can be initialized using a random number generator that assigns a randomly computed value between 0 and 1 to each of the weights. In lines 4-6, the training input layer [symbol] and the training output layer [symbol] are received. In the for-loop beginning in line 7, each node qⱼ in the input layer is assigned to a hidden unit aⱼ. In the for-loop beginning in line 9, for each layer l between 2 and L, h(sumᵢ) is calculated and assigned to a hidden unit aᵢ for each node, where h denotes an activation function. The activation function, h, can be a threshold activation function that outputs a value 1 when the input is positive and a value 0 otherwise. Alternatively, the activation function can be a sigmoid function. Examples of sigmoid activation functions include h(sumᵢ)=tanh(sumᵢ) and h(sumᵢ)=1/(1+e^{-sum}^{ᵢ}). In the for-loop beginning in line 12, for each node in the output layer an error, denoted by Errorᵢ, and a modified error Δᵢ are calculated, where h′ represents the first derivative of the activation function h. The modified error corresponds to a fraction of the error in the nodes of the output layer. In line 15 a for-loop executes back propagation and weight updates beginning with L−1 and ends with the input layer (i.e., l=1). In the for-loop beginning in line 16, the modified error is calculated for each hidden layer l, and in the for-loop beginning in line 18, the weights are updated for each node in the hidden layer l+1 according to gradient descent where the parameter α is the learning rate. In the for-loop beginning in line 20, when the Errorᵢ for each node in the output layer is less than a defined error threshold, lines 4 through 21 are repeated for a different set of input values in lines 5 and 6. When there are no more sets of input values (i.e., no more training data [symbol] and [symbol] ) to train the weights of the neural network, the process stops. Otherwise, if one of the errors Errorᵢ exceeds or equals the predefined threshold, lines 9 through 21 are repeated. Note that in other embodiments rather than using a threshold, lines 9 through 19 can be repeated for a preset number of iterations.

Lines 4 through 21 can be repeated for a large set of training data to computationally generate a set of weights that define a relationship between the input layer and the output layer. FIG. 28C shows an example of simple neural network 2816 with an input layer composed of two values q₁ and q₂ and an output layer composed of a single value r₁. In this example, only one hidden layer of three hidden units a₁, a₂, and a₃ is selected to determine a set of weights. In FIG. 28, a first set of weights that link the values q₁ and q₂ to the hidden units a₁, a₂, and a₃ are denoted by W′₁₁⁽¹⁾, W′₂₁⁽¹⁾, W′₁₂⁽¹⁾, W′₁₃⁽¹⁾, W′₂₂⁽¹⁾, and, W′₂₃⁽¹⁾, and a second set of weights that link the hidden units a₁, a₂, and a₃ to the value r₁ are denoted by W′₁₁⁽²⁾, W′₂₁⁽²⁾, W′₃₁⁽²⁾, W′₁₂⁽²⁾, W′₂₂⁽²⁾, and, W′₃₂⁽²⁾. The weights can be calculated using a feed-forward neural network, such as the pseudo-code described above with reference to FIG. 28B. In the example of FIG. 28C, an expression 2818 is derived from the neural network for the output r₁.

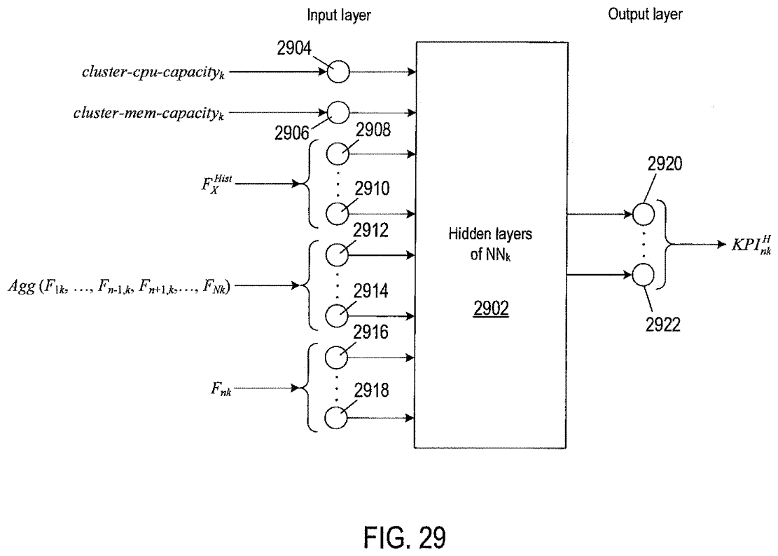

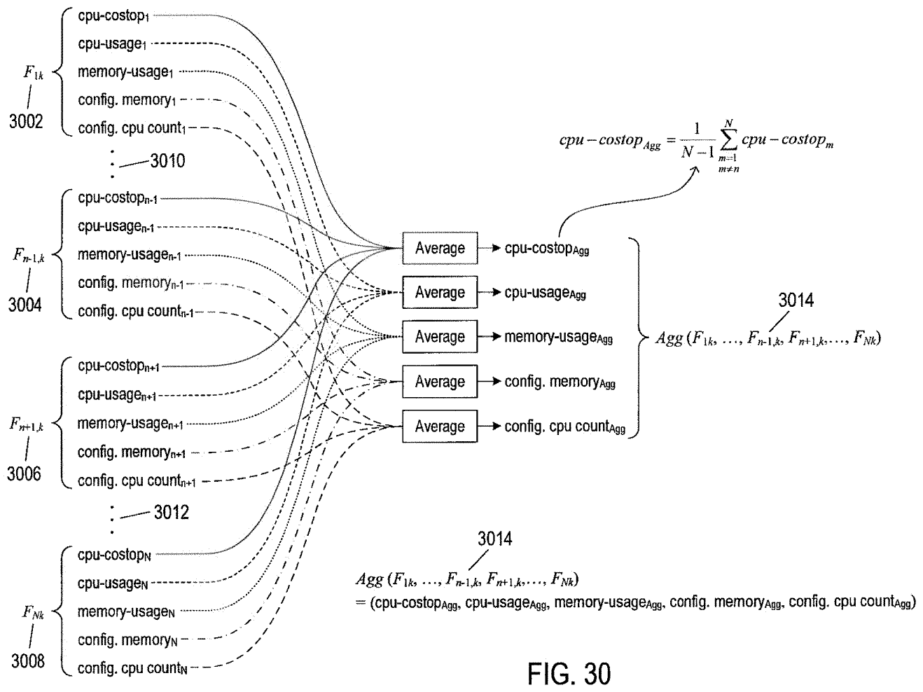

FIG. 29 shows an example of an input layer and an output layer for training a neural network NNₖ of flattened subgraph FSGₖ. Block 2902 represents the hidden layers of the neural network NNₖ. Input nodes 2904 and 2906 are cluster-cpu-capacityₖ and cluster-mem-capacityₖ of hosts represented in the flattened subgraph FSGₖ as described above with reference to FIG. 24A. Input nodes 2908 through 2910 are historical candidate fragment metrics, denoted by F_{X}^{Hist}, of Fragment_{X}. The historical candidate fragment metrics F_{X}^{Hist} are obtained by aggregating features of VMs of Fragment_{X} recorded in a historical time window as described above with reference to FIGS. 25 and 26. The values at input nodes 2912 through 2914 are obtained by aggregating fragment metrics F₁ₖ, . . . , F_{n-1,k}, F_{n+1,k}, . . . , F_{N}_{ₖ}ₖ, where n=1, . . . , Nₖ is a fragment index and Nₖ denotes the number of fragments of the flattened subgraph FSGₖ. Note that the aggregated features Fₙₖ are excluded from aggregating the aggregated features, as described below with reference to FIG. 30. Each of the aggregated features, such as fragment metrics F_{n+1,k}, is obtained by aggregating features of a corresponding fragment of the flattened subgraph FSGₖ as described above with reference to FIGS. 25 and 26. Input ports 2916 through 2918 represent fragment metrics Fₙₖ of Fragmentₙₖ obtained as described above with reference to FIGS. 25 and 26, The weights of the hidden layers of the neural network NNₖ are optimized as described above with reference to FIG. 28B using a historical KPI of the Fragmentₙₖ denoted by KPIₙₖ^{H}. The historical KPI KPIₙₖ^{H} represents historical values of the KPI recorded in a historical time window for Fragmentₙₖ. Nodes 2920 through 2922 of the output layer represent values of the historical KPI KPIₙₖ^{H}.

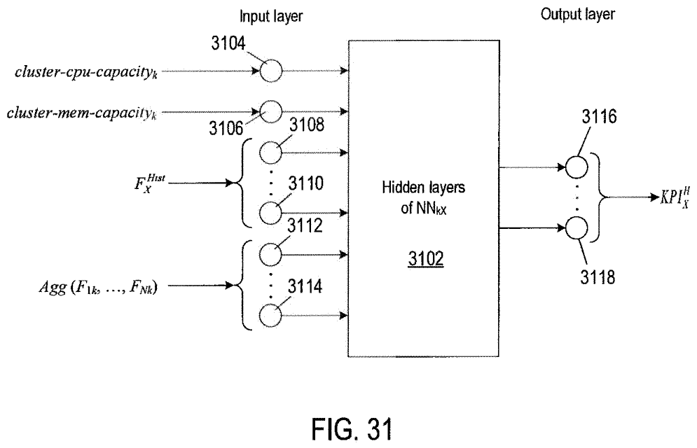

FIG. 30 shows an example of aggregating fragment metrics F₁ₖ, . . . , F_{n-1,k}, F_{n+1,k}, . . . , F_{N}_{ₖ}ₖ of a flattened subgraph FSGₖ, where the fragment metrics Fₙₖ are excluded. FIG. 31 shows examples of fragment metrics F₁ₖ 3102. F_{n-1,k} 3104, F_{n+1,k} 3106, and F_{N}_{ₖ}ₖ 3108 obtained for each fragment of the flattened subgraph FSGₖ. Ellipses 3110 and 3112 represent fragment metrics that are not shown. Note that fragment metrics Fₙₖ of Fragmentₙₖ of the flattened subgraph FSGₖ is excluded. The cpu costop, cpu usage, memory usage, configuration memory, and configuration cpu count metrics of the features are averaged to obtain metrics of aggregated fragment metrics denoted by Agg(F₁ₖ, . . . , F_{n-1,k}, F_{n+1,k}, . . . , F_{N}_{ₖ}ₖ) 3114.

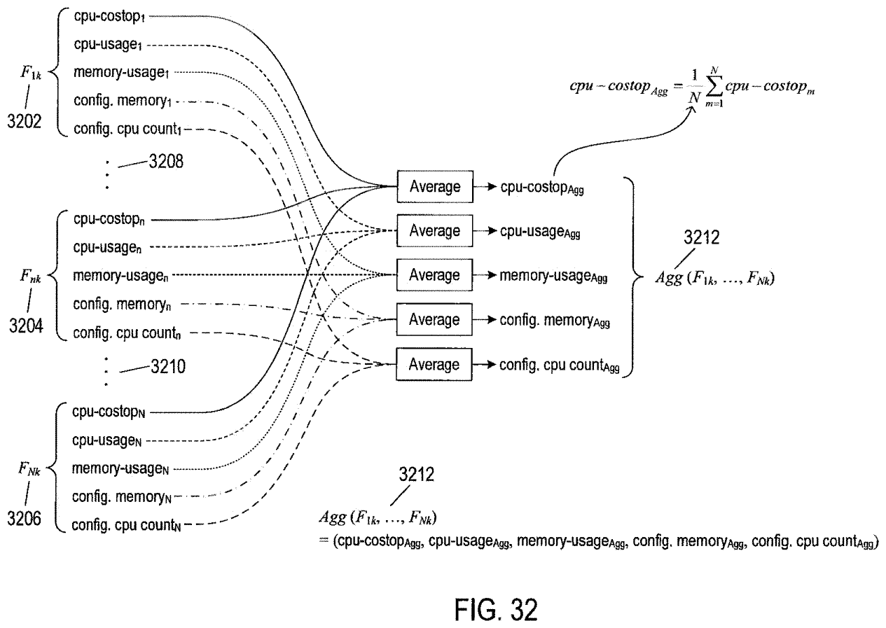

FIG. 31 shows an example of an input layer and an output layer for training a neural network NN_{kX} for candidate fragment Fragment_{X} of a candidate flattened subgraph CFSGₖ. Block 3102 represents the hidden layers of a neural network NN_{kX} for the Fragments. Input nodes 3104 and 3106 are cluster-cpu-capacityₖ and cluster-mem-capacityₖ of hosts represented in the flattened subgraph FSGₖ as described above with reference to FIG. 24A. Input nodes 3108 through 3110 are historical features F_{X}^{Hist} of Fragment_{X}. The values at input nodes 3112 through 3114 are obtained by aggregating fragment metrics F₁ₖ, . . . , Fₙₖ, . . . , F_{N}_{ₖ}ₖ, where the fragment metrics Fₙₖ are included, as described below with reference to FIG. 32. The weights of the hidden layers of the neural network NN_{kX} are optimized as described above with reference to FIG. 28B using a historical KPI of the Fragment_{X} denoted by KPI_{X}^{H}. The historical KPI KPI_{X}^{H} represents historical values of the KPI recorded in a historical time window for Fragment_{X}. Nodes 3116 through 3118 of the output layer represent values of the historical KPI KPI_{X}^{H}.

FIG. 32 shows an example of aggregating fragment metrics F₁ₖ, . . . , Fₙₖ, . . . , F_{N}_{ₖ}ₖ of the flattened subgraph FSGₖ. FIG. 32 shows examples of fragment metrics F₁ₖ 3202. Fₙₖ 3204, and F_{N}_{ₖ}ₖ 3206 obtained for each fragment of the flattened subgraph FSGₖ. Ellipses 3208 and 3210 represent aggregated features that are not shown. The cpu costop, cpu usage, memory usage, configuration memory, and configuration cpu count metrics of the features are averaged to obtain metrics of aggregated fragment metrics denoted by Agg(F₁ₖ, . . . , F_{Nk}) 3212.

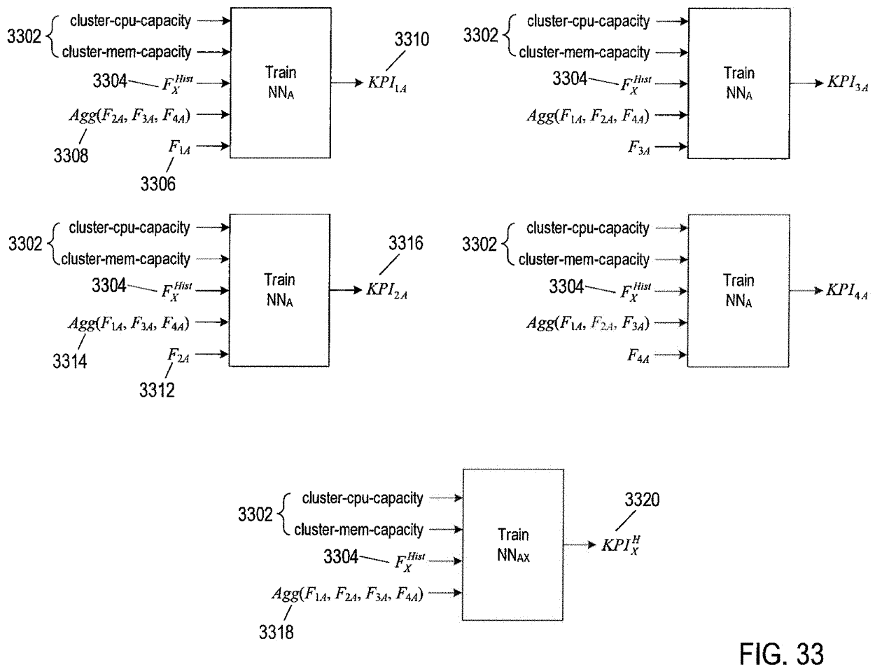

FIG. 33 shows an example of training a neural network NN_{A} for the fragments. Fragment_{nA}, where n=1, 2, 3, 4, and training a neural network NN_{AX} for Fragments of the flattened subgraph 2701 in FIG. 27. The neural network NN_{A} is trained with the same cluster capacity metrics 3302 and historical candidate fragment metrics F_{X}^{Hist} 3304 but with the different fragment metrics, aggregated fragment metrics, and KPIs of the fragments Fragment_{nA}, for n=1, 2, 3, 4. For example, the neural network NN_{A} may first be trained with fragment metrics F_{1A} 3306, aggregated fragment metrics Agg(F_{2A}, F_{3A}, F_{4A}) 3308, and the KPI_{1A} 3310 of Fragment_{1A} as described above with reference to FIGS. 28B, 29, and 30. The neural network NN_{A} is next trained with fragment metrics F_{2A} 3312, aggregated fragment metrics Agg(F_{1A}, F_{3A}, F_{4A}) 3314, and the KPI_{2A} 3316 of Fragment_{2A} as described above with reference to FIGS. 28B, 29, and 30. FIG. 33 also shows the neural network NN_{AX} trained with the cluster capacity metrics 3302, aggregated fragment metrics Agg(F_{1A}, F_{2A}, F_{3A}, F_{4A}) 3318, historical candidate fragment metrics F_{X}^{Hist} 3304, and historical KPI KPI_{X}^{H} 3320 of Fragment_{X} as described above with reference to FIGS. 28B, 31, and 32.

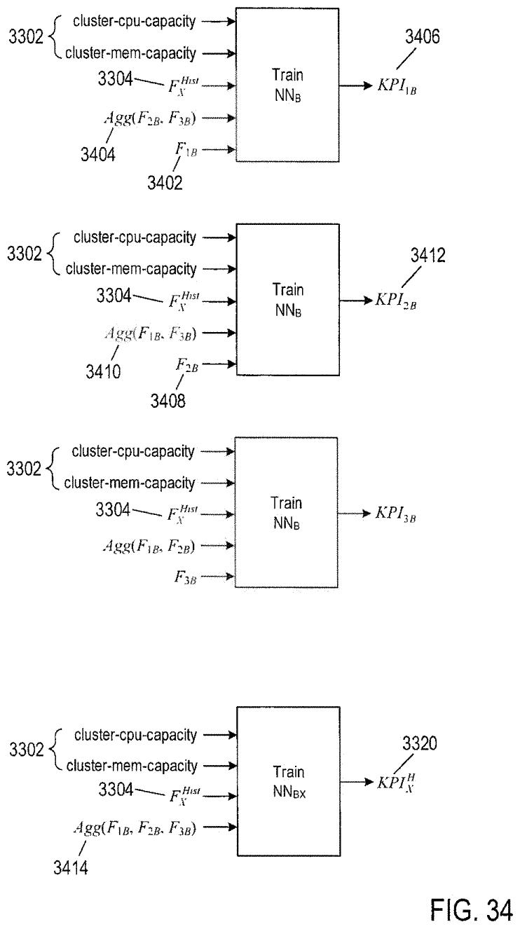

FIG. 34 shows an example of training a neural network NN_{B} for the fragments. Fragment_{nB}, where n=1, 2, 3, and training a neural network NN_{BX} for Fragment_{X} of the flattened subgraph 2703 in FIG. 27. The neural network NN_{B} is trained with the cluster capacity metrics 3302 and historical candidate fragment metrics F_{X}^{Hist} 3304 but with the different fragment metrics, aggregated fragment metrics, and KPIs of the fragments Fragment_{nB}, for n=1, 2, 3. For example, the neural network NN_{B} may first be trained with fragment metrics F_{1B} 3402, aggregated fragment metrics Agg(F_{2B}, F_{3B}) 3404, and the KPI_{1B} 3406 of Fragment_{1B} as described above with reference to FIGS. 28B, 29, and 30. The neural network NN_{B} is next trained with fragment metrics F_{2B} 3408, aggregated fragment metrics Agg(F_{1B}, F_{3B}) 3310, and the KPI_{2B} 3412 of Fragment_{2B} as described above with reference to FIGS. 28B, 29, and 30. FIG. 34 also shows the neural network NN_{BX} trained with the cluster capacity metrics 3302, aggregated fragment metrics Agg(F_{1B}, F_{2B}, F_{3B}) 3414, historical candidate fragment metrics F_{X}^{Hist} 3304, and historical KPI KPI_{X}^{H} 3320 of Fragment_{X} as described above with reference to FIGS. 28B, 31, and 32.

The training neural networks NNₖ and NN_{kX}, for k=1, . . . , S, are subsequently used to predict KPIs for fragments Fragmentₙₖ, where n=1, . . . , N, and predict KPIs for Fragment_{X} of the candidate flattened subgraphs FSGₖ. The predicted KPIs are a prediction of the behavior of the subsystem that corresponds to the subgraph FSGₖ.

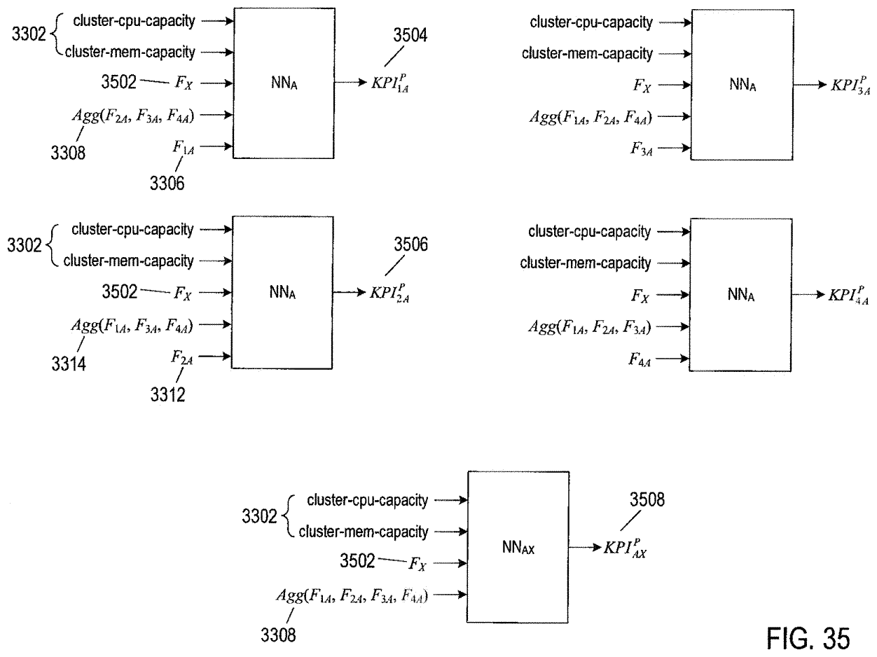

FIG. 35 shows an example of using the trained neural networks NN_{A} and NN_{AX} obtained in FIG. 33 to compute predicted KPIs for each fragment of the candidate flattened subgraph 2701 in FIG. 27. The trained neural network NN_{A} is used to compute a predicted KPIs for each of the fragments Fragment_{nA}, where n=1, 2, 3, 4. FIG. 35 shows predicted KPIs KPI_{1A}^{P}, KPI_{2A}^{P}, KPI_{3A}^{P}, and KPI_{4A}^{P} obtained for each of the fragments Fragment_{nA}, where n=1, 2, 3, 4, with recently recorded fragment metrics F_{X} for Fragment_{X}. For example, the cluster capacity metrics 3302, aggregated fragment metrics Agg(F_{2A}, F_{3A}, F_{4A}) 3308, fragment metrics F_{1A} 3306, and recently recorded fragment metrics F_{X} 3502 are input to the neural network NN_{A} to obtain a predicted KPI KPI_{1A}^{P} 3504 for Fragment_{1A}. Similarly, the cluster capacity metrics 3302, aggregated fragment metrics Agg(F_{1A}, F_{3A}, F_{4A}) 3308, fragment metrics F_{2A} 3306, and recently recorded fragment metrics F_{X} 3502 are input to the neural network NN_{A} to obtain a predicted KPI KPI_{2A}^{P} 3506 for Fragment_{2A}. FIG. 35 shows the trained neural network NN_{AX} is used to compute a predicted KPI KPI_{AX}^{P} 3508 for Fragment_{X} from the cluster capacity metrics 3302, aggregated fragment metrics Agg(F_{1A}, F_{2A}, F_{3A}, F_{4A}) 3308, and recently recorded fragment metrics F_{X} 3502.

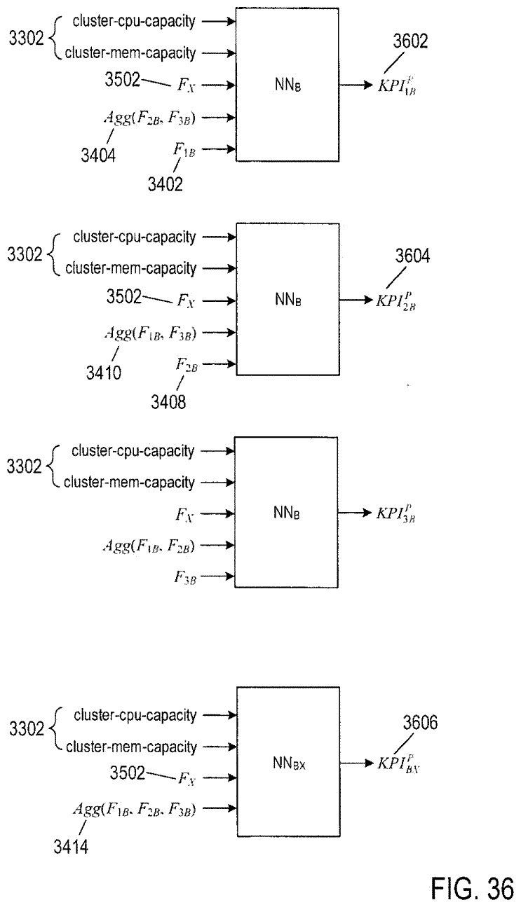

FIG. 36 shows an example of using the trained neural networks NN_{B} and NN_{BX} obtained in FIG. 34 to compute predicted KPIs for each fragment of the candidate flattened subgraph 2703 in FIG. 27. The trained neural network NN_{B} is used to compute a predicted KPIs for each of the fragments Fragment_{nB}, where n=1, 2, 3. FIG. 36 shows predicted KPIs KPI_{1B}^{P}, KPI_{2B}^{P}, and KPI_{3B}^{P} obtained for each of the fragments Fragment_{nB}, where n=1, 2, 3, with recently recorded fragment metrics F_{X} for Fragment_{X}. For example, the cluster capacity metrics 3302, aggregated fragment metrics Agg(F_{2B}, F_{3B}) 3404, fragment metrics F_{1B} 3402, and recently recorded fragment metrics F_{X} 3502 are input to the neural network NN_{B} to obtain a predicted KPI KPI_{1B}^{P} 3602 for Fragment_{1B}. Similarly, the cluster capacity metrics 3302, aggregated fragment metrics Agg(F_{1B}, F_{3B}) 3410, fragment metrics F_{2B} 3408, and recently recorded fragment metrics F_{X} 3502 are input to the neural network NN_{B} to obtain a predicted KPI KPI_{2B}^{P} 3604 for Fragment_{2B}. FIG. 35 shows the trained neural network NN_{BX} is used to compute a predicted KPI KPI_{BX}^{P} 3606 for Fragment_{X} from the cluster capacity metrics 3302, aggregated fragment metrics Agg(F_{1B}, F_{2B}, F_{3B}) 3308, and recently recorded fragment metrics F_{X} 3502.

The management server 1330 uses the predicted KPIs of each fragment to determine whether Fragment_{X} can be added to the distributed computing environment without decreasing performance of the distributed application. When Fragment_{X} can be added, the management server 1330 uses the predicted KPIs to determine which subgraph the Fragment_{X} should be added to based on the most favorable predicted KPIs. The management server 1330 adds the components of the Fragment_{X} to the subsystem that corresponds to the subgraph with the most favorable predicted KPIs.

In one implementation, the predicted KPIs of the fragments are DRS scores. Let Th_{DRS} be a DRS score threshold. The management server 1330 compares the predicted KPIs to the DRS score threshold for acceptance or rejection of the proposed addition of the candidate application component. If the predicted KPIs satisfy the following conditions:

KPIₙₖ^{P}<Th_{DRS} (9a)

KPI_{kX}^{P}<Th_{DRS} (9b)

for n=1, . . . , Nₖ and k=1, . . . , S, then Fragment_{X} is identified as being unacceptable (i.e., low DRS scores), or ineligible, for addition to the distributed computing environment. The Fragment_{X} decreases performance of the distributed application, and the proposal to add the Fragment_{X} is automatically rejected. Alternatively, if the predicted KPIs do not satisfy the conditions in Equations (9a) and (9b), addition of Fragment_{X} is acceptable. The management server 1330 then determines which of the candidate flattened subgraphs Fragment_{X} can be added to by computing an average predicted KPI for each of the candidate flattened subgraphs as follows:

$${KPI}_{k}^{A v e} = \frac{1}{{N}_{k} + 1} [ {\sum }_{n = 1}^{{N}_{k}} {KPI}_{n k}^{P} + {KPI}_{kX}^{P} ] \qquad ( 10 )$$

The Fragment_{X} is added to the subsystem that corresponds to the candidate flattened subgraph with the largest KPIₖ^{Ave} (i.e., largest average DRS score). The management server 1330 automatically adds the components of Fragment_{X} to the subsystem that corresponds to the candidate flattened subgraph with the largest average predicted KPI.

In an alternative implementation, the average predicted KPI compute in Equation (10) for each candidate flattened subgraph is used to evaluate acceptance or rejection of the candidate application component. If the average predicted KPIs for each of the candidate flattened subgraphs determined in Equation (10) are less than the Th_{DRS}, addition of the candidate application component in Fragment_{X} is rejected. A system administrator is notified in a graphical user interface on a management console that the proposed addition of the candidate application component is unacceptable has been rejected because such an addition would decrease performance of the distributed application.

For example, suppose the management server 1330 determines the predicted KPIs computed in FIGS. 35 and 36 are acceptable according to the conditions in Equations (9a) and (9b). The management server 1330 computes an average predicted KPI for the candidate flatten subgraph 2701 of FIG. 27 as follows:

$${KPI}_{A}^{A v e} = \frac{1}{5} [ {\sum }_{n = 1}^{4} {KPI}_{n A}^{P} + {KPI}_{A X}^{P} ]$$

The management server 1330 computes an average predicted KPI for the candidate flattened subgraph 2703 of FIG. 27 as follows:

$${KPI}_{B}^{A v e} = \frac{1}{4} [ {\sum }_{n = 1}^{3} {KPI}_{n B}^{P} + K P {I}_{B X}^{P} ]$$

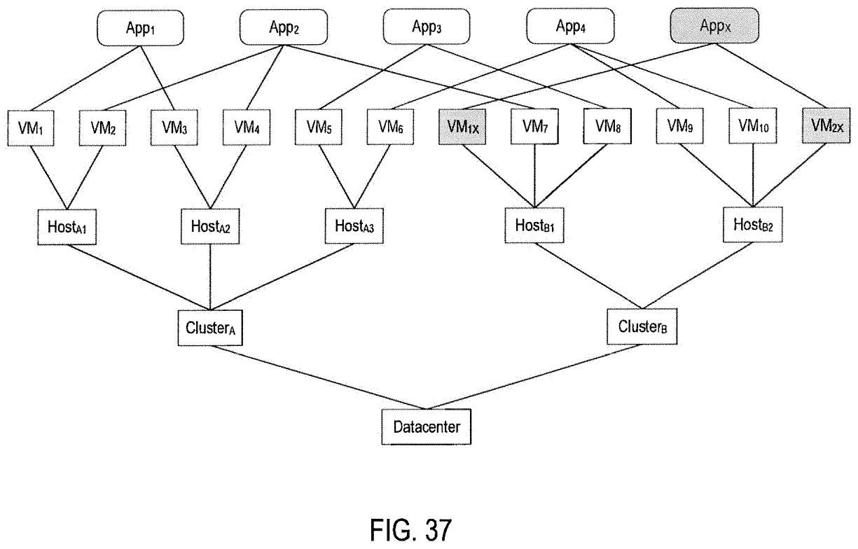

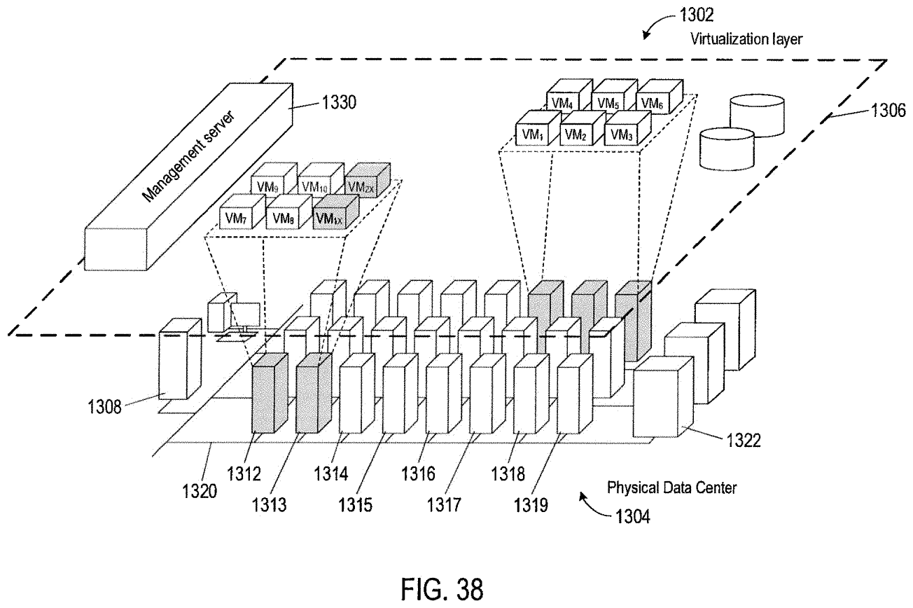

In this example, if KPI_{B}^{Ave}>KPI_{A}^{Ave}, the management server 1330 automatically migrates, or loads and starts. VM_{1X} and VM_{2X} on server computers 1312 and 1313 in FIG. 37. FIG. 38 shows a graph of the distributed computing environment with VM_{1X} on host_{B1} and VM_{2X} on host_{B2}. In an alternative implementation, if Th_{DRS}>KPI_{A}^{Ave} and Th_{DRS}>KPI_{B}^{Ave}, the proposal to add the Fragment_{X} is rejected because the average predicted KPIs predict that performance of the distributed application will decrease if Fragment_{X} is added to the distributed computing environment of the distributed application.

In alternative implementation, the predicted KPIs of the fragments may be application throughput. The average predicted KPIs of the candidate fragment subgraphs are evaluated in the same manner as described above for the DRS score.

In an alternative implementation, the predicted KPIs of the fragments are application latency metric or a data packet drops metric. The management server 1330 computes an average KPI for each of the candidate flattened subgraphs as described above with reference to FIG. 10. In this case, the management server 1330 automatically adds components of the Fragment_{X} to the subsystem that corresponds to the candidate flattened subgraph with the smallest KPIₖ^{Ave}. On the other hand, if the average predicted KPIs for each of the candidate flattened subgraphs determined in Equation (10) are greater than an acceptable latency threshold or number of acceptable packet drops threshold, addition of the candidate application component is rejected. A system administrator is notified in a graphical user interface on a management console of the data center that the proposed addition of the candidate application component has been rejected because such an addition would be detrimental to performance of the distributed application.

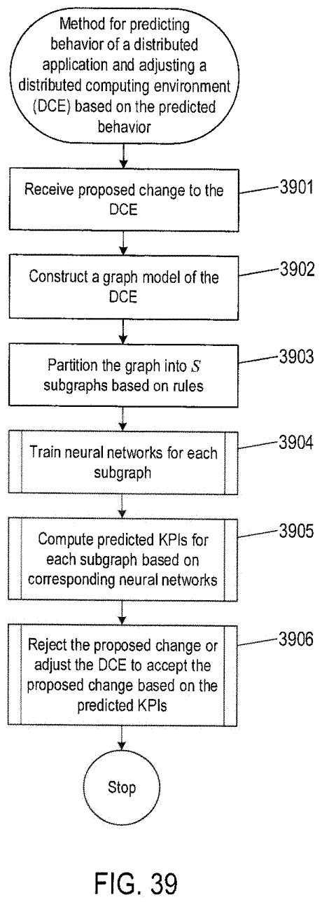

The method described below with reference to FIGS. 39-44 is executed by the management server 1330 that is stored in one or more data-storage devices as machine-readable instructions and executed by one or more processors of a computer system, such as the computer system shown in FIG. 1.

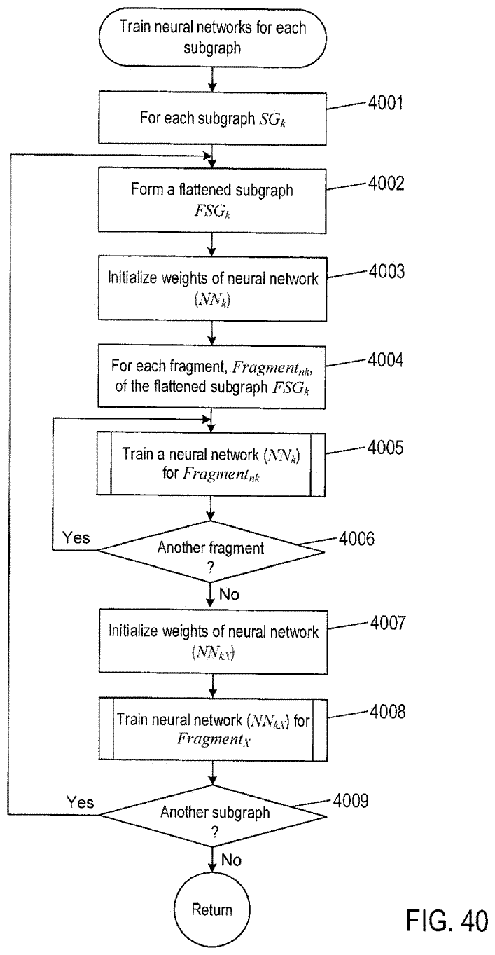

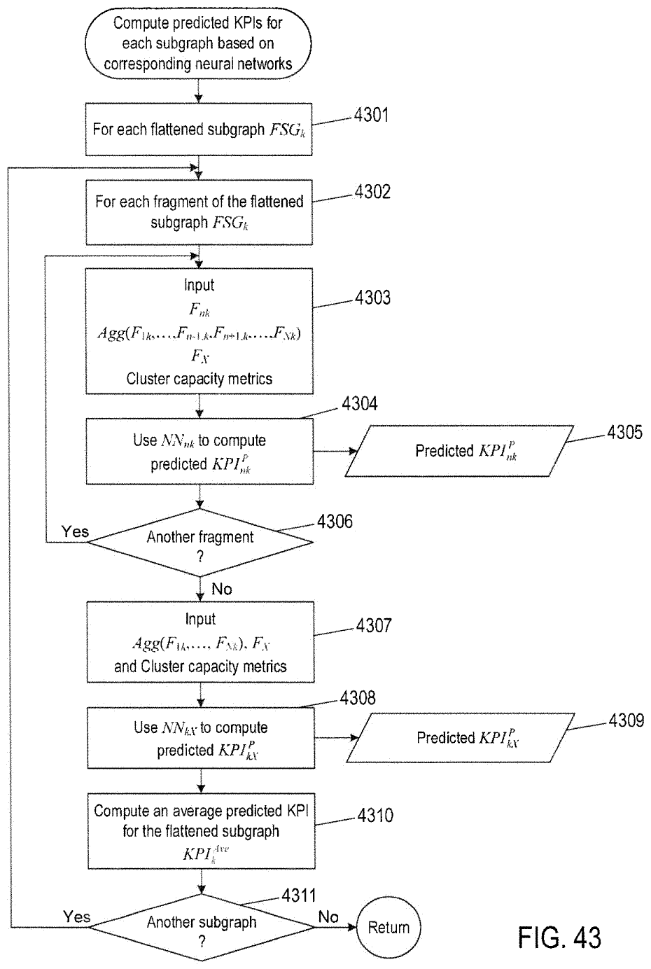

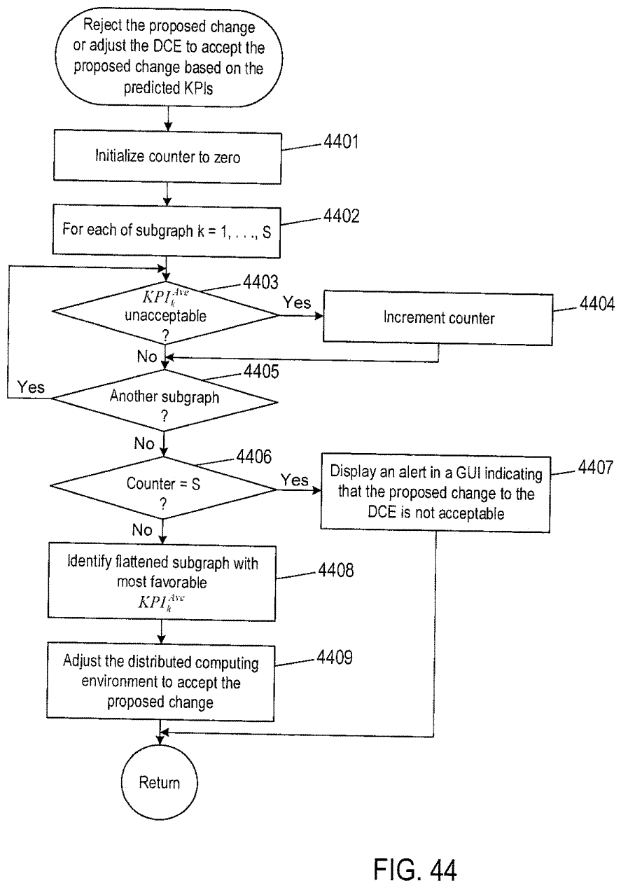

FIG. 39 is a flow diagram of a method for predicting behavior of a distributed application and adjust a distributed computing environment based on the predicted behavior. In block 3901, a user initiates automated computer-implemented method described in blocks 3902-3906 via a graphical user interface (“GUI”) of a system administrator console described above with reference to FIG. 13. For example, a user may submit to the management server 1330 via the GUI a proposed change to a distributed computing environment of a distributed application, such as adding an application component to the distributed computing environment. In block 3902, a graph model of the distributed computing environment of the distributed application is constructed by the management server 1330 as described above with reference to FIG. 17. In block 3903, the graph is partitioned into S subgraphs. SGₖ, where k=1, . . . , S, based on a user-selected rule. Each subgraph corresponds to a subsystem of the distributed computing environment as described above with reference to FIGS. 18-22B. In block 3904, a “train neural networks for each subgraph” procedure is performed. An example implementation of the procedure “train neural networks for each subgraph” is performed in FIG. 40. In block 3905, a “compute predicted KPIs for each subgraph based on corresponding neural networks” procedure is performed. An example implementation of the procedure “compute predicted KPIs for each subgraph based on corresponding neural networks” is performed in FIG. 43. In block 3906, a “reject the proposed change or adjust the distributed computing environment to accept the proposed change based on the predicted KPIs” procedure is performed. An example implementation of the “reject the proposed change or adjust the distributed computing environment to accept the proposed change based on the predicted KPIs” procedure is performed in FIG. 44.

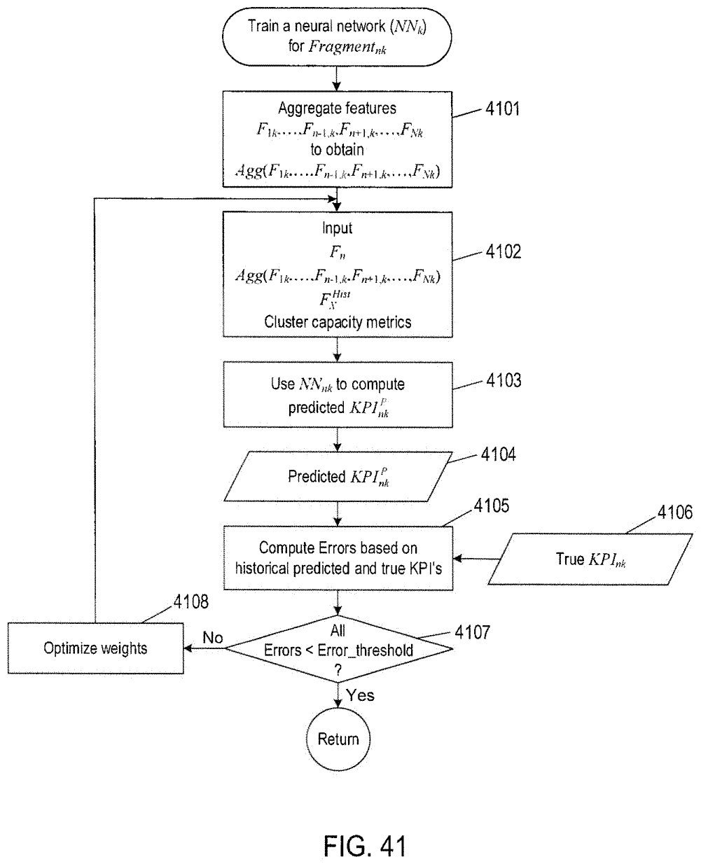

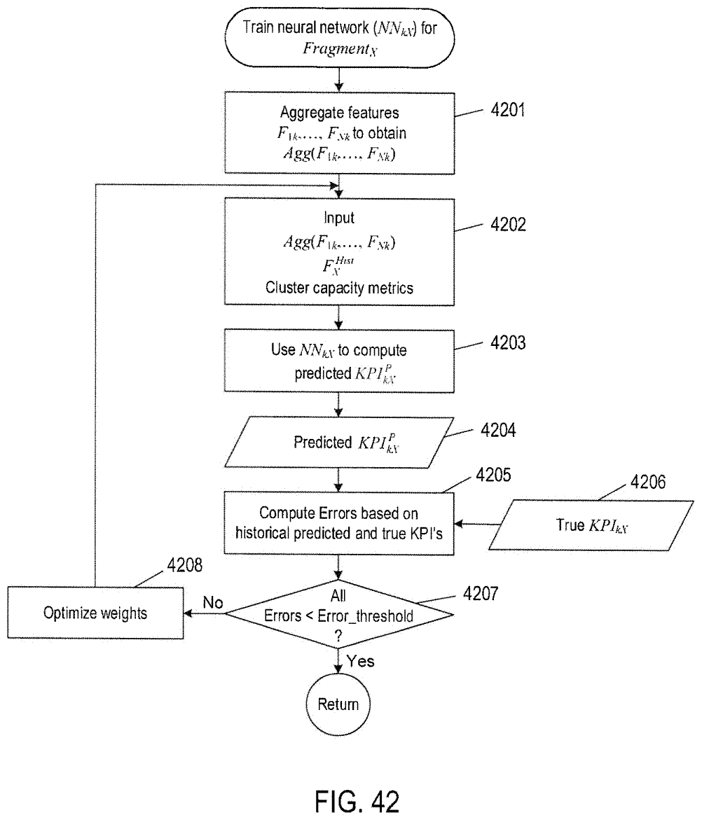

FIG. 40 is a “train neural networks for each subgraph” procedure performed in block 3904 of FIG. 39. A loop beginning with block 4001 repeats the computational operations represented by blocks 4002-4008 for each subgraph SGₖ, where k=1, . . . , S. In block 4002, the management server 1330 forms a flattened subgraph FSGₖ as described above with reference to FIGS. 23A-26. In block 4003, weights of a neural network NNₖ are initialized as described above with reference to lines 1 and 2 of the pseudo-code in FIG. 28B. A loop beginning with block 4004 repeats the computational operations represented by block 4005 for each fragment Fragmentₙₖ, where n=1, . . . , Nₖ, of the flattened subgraph FSGₖ. In block 4005, a “train a neural network (NNₖ) to predict a KPI for Fragmentₙₖ” procedure is performed. An example implementation of the “train a neural network (NNₖ) to predict a KPI for Fragmentₙₖ” procedure is performed in FIG. 41. In decision block 4006, the operation represented by block 4005 is repeated for each fragment of the flattened subgraph. In block 4007, weights of a neural network NN_{kX} are initialized as described above with reference to lines 1 and 2 of the pseudo-code in FIG. 28B. In block 4008, a “train a neural network (NN_{kX}) to predict a KPI for Fragment_{X}” procedure is performed. An example implementation of the “train a neural network (NN_{kX}) to predict a KPI for Fragment_{X}” procedure is performed in FIG. 42. In decision block 4009, the operation represented by block 4008 is repeated for each fragment of the flattened subgraph.

FIG. 41 is a flow diagram of “train a neural network (NNₖ) for Fragmentₙₖ” procedure performed in block 4005 of FIG. 40. In block 4101, fragment metrics F₁ₖ, . . . , F_{n-1,k}, F_{n+1,k}, . . . , F_{Nk} are aggregated to obtain aggregated fragment metrics Agg(F₁ₖ, . . . , F_{n-1,k}, F_{n+1,k}, . . . , F_{Nk}) as described above with reference to FIG. 30. In block 4102, fragment metric Fₙₖ, aggregated fragment metrics Agg(F₁ₖ, . . . , F_{n-1,k}, F_{n+1,k}, . . . , F_{Nk}), historical fragment metrics F_{X}^{Hist} of Fragment_{X}, and cluster capacity metrics are input to the neural network NNₙₖ as described above with reference to FIG. 31. In block 4103, a predicted KPI KPIₙₖ^{P} is output from the neural network NNₙₖ as described above with reference to FIG. 30. In block 4105, errors are computed between the predicted KPIₙₖ 4105 and the true KPIₙₖ 4106 as described above with reference to lines 12-14 of the pseudo-code in FIG. 28B. In decision block 4107, when one or more of the errors computed in block 4105 is greater than the error threshold, control flows to block 4108. Otherwise, the process terminates, and control returns to FIG. 40. In block 4108, the weights are adjusted as described above with reference to lines 15-19 of FIG. 28B.

FIG. 42 is a flow diagram of “train a neural network (NN_{kX}) for Fragment_{X}” procedure performed in block 4008 of FIG. 40. In block 4201, fragment metrics F₁ₖ, . . . , Fₙₖ, . . . , F_{Nk} are aggregated as described above with reference to FIG. 32. In block 4202, aggregated fragment metrics Agg(F₁ₖ, . . . , F_{Nk}), historical fragment metrics F_{X}^{Hist} of Fragment_{X}, and cluster capacity metrics are input to the neural network NN_{kX} as described above with reference to FIG. 31. In block 4203, a predicted KPI KPI_{kX}^{P} 4204 is output from the neural network NN_{kX}. In block 4205, errors are computed between the predicted KPI_{kX}^{P} 4205 and the true KPI_{kX} 4206 as described above with reference to lines 12-14 of the pseudo-code in FIG. 28B. In decision block 4207, when one or more of the errors computed in block 4205 is greater than the error threshold, control flows to block 4208. Otherwise, the process terminates, and control returns to FIG. 29. In block 4208, the weights are adjusted as described above with reference to lines 15-19 of FIG. 28B.

FIG. 43 is a flow diagram of “compute predicted KPIs for each subgraph based on corresponding neural networks” procedure performed in block 3905 of FIG. 39. A loop beginning with block 4301 repeats the operations represented by blocks 4302-4309 for each subgraph. A loop beginning with block 4302 repeats the operations represented by blocks 4303-4305 for each fragment of the flattened subgraph. In block 4303, fragment metric Fₙₖ, aggregated fragment metrics Agg(F₁ₖ, . . . , F_{n-1,k}, F_{n+1,k}, . . . , F_{Nk}), fragment metrics F_{X} of Fragment_{X}, and cluster capacity metrics are input to the trained neural network NNₙₖ. In block 4304, a predicted KPI KPIₙₖ^{P} 4305 is output from the neural network NNₙₖ. In decision block 4306, the operations represented by blocks 4303-4305 are repeated for another fragment. In block 4307, aggregated fragment metrics Agg(F₁ₖ, . . . , F_{Nk}), fragment metrics F_{X} of Fragment_{X}, and cluster capacity metrics are input to the neural network NN_{kX}. In block 4308, a predicted KPI KPI_{kX}^{P} 4309 is output from the neural network NN_{kX}. In block 4310, an average KPI. KPIₖ^{Ave}, is computed as described above with reference to Equation (10). In block 4311, the operations represented by blocks 4302-43010 are repeated for another subgraph.

FIG. 44 is a flow diagram of the “reject the proposed change or adjust the distributed computing environment to accept the proposed change based on the predicted KPIs” procedure performed in block 3906 of FIG. 39. In block 4401, a counter is initialized to zero. The counter keeps track of the number of average KPIs of the flattened subgraphs that are unacceptable for receiving the proposed change. A loop beginning with block 4402 repeats the computational operations represented by blocks 4403-4405 for each subgraph (i.e., for k=1, . . . , S). In decision block 4403, when the average KPI of the corresponding flattened subgraph computed in block 4310 is unacceptable, control flows to block 4404 in which the counter is incremented. Whether the average KPI is acceptable depends on the type of average KPI used. For example, when the average KPI is the average DRS score, average KPI above a threshold are acceptable. On the other hand, when the average KPI is latency or number of data packet drops, average KPI below a threshold is acceptable. In decision block 4405, the operations represented by blocks 4403-4404 are repeated for another flattened subgraph. In decision block 4406, when the counter equals the number of subgraphs, then all of the average KPIs are unacceptable control flows to block 4407. In block 4407, an alert is displayed on a graphical user interface indicating that the proposed change is not acceptable and is rejected. In block 4408, the flattened subgraph with the most favorable average KPI is identified. For example, in the case of the average KPI is the average DRS score, the flattened subgraph with the largest average KPI is the most favorable. On the other hand, in the case of the average KPI is the average latency, the flattened subgraph with the smallest average KPI is the most favorable. In block 4409, the management server 1330 automatically adjust the DCE to accept the proposed change.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An automated computer-implemented process for predicting behavior of a distributed application in response to a proposal to add a candidate application component to a distributed computing environment in which the distributed application is executed, the process comprising:
constructing a graph model of the distributed computing environment;
partitioning the graph model into subgraphs based on a rule for partitioning the distributed computing environment into subsystems, wherein each subgraph is a model of a subsystem of objects of the distributed computing environment;
training neural networks for each subgraph based on the proposal to add the candidate application component the corresponding subsystem;
using the trained neural networks associated with each subgraph to predict the behavior of each subsystem to a proposal to add the candidate application to the subsystem; and
based on the predicted behavior of each subsystem, adding the candidate application to a subsystem or rejecting the proposal to add the candidate application.

2. The process of claim 1 wherein partitioning the graph into subgraphs based on the rule comprises performing one of
partitioning the graph into subgraphs such that each subgraph corresponds to a cluster of the distributed computing environment;
partitioning the graph into subgraphs such that each subgraph corresponds to objects of the distributed computing environment that receive electrical power from the same power source; and
partitioning the graph into subgraphs such that each subgraph comprises correlated objects of the distributed computing environment.

3. The process of claim 1 wherein training neural networks for each subgraph comprises:
for each subgraph,
for each application component of the subgraph, forming a fragment by aggregating components and metrics of one or more virtual machines used to execute the application component,
forming a candidate fragment by aggregating components and metrics of one or more VMs used to execute the candidate application component,
forming a candidate flattened subgraph from the fragments and the candidate fragment,
training a first neural network to generate a key performance indicators (“KPIs”) for each fragment of the candidate flattened subgraph, and
training a second neural network to generate a KPI of the candidate fragment.

4. The process of claim 1 wherein using the trained neural networks associated with each subgraph to predict the behavior of each subsystem comprises:
for each subgraph,
using a first of the trained neural networks to generate a predicted KPI for each fragment of the subgraph,
using a second of the trained neural networks to generate a predicted KPI for the candidate application, and
computing an average predicted KPI of the subgraph based on the predicted KPIs of fragments of the subgraph and a predicted KPI.

5. The process of claim 1 where adding the candidate application component to the subsystem comprises:
computing an average predicted KPI for each subsystem based on the predicted behavior of each subsystem;
for each subsystem comparing the average predicted KPI to an acceptable threshold to identify one or more of the average predicted KPIs as acceptable or unacceptable; and
adding the candidate application component to the subsystem with a corresponding with an average predicted KPI that is more acceptable than the average predicted KPIs of the other subsystems.

6. The process of claim 1 wherein rejecting the proposal to add the candidate application comprises:
rejecting the candidate application component for addition to the distributed computing environment when the predicted behavior of the subsystems are unacceptable; and
displaying an alert in a graphical user interface, the alert indicating that the candidate application is unacceptable for addition to the distributed computing environment.

7. A computer system for predicting behavior of a distributed application in response to a proposed change to a distributed computing environment in which the distributed application is executed, the system comprising:
one or more processors;
one or more data-storage devices; and
machine-readable instructions stored in the one or more data-storage devices that when executed using the one or more processors controls the system to perform operations comprising:
constructing a graph model of the distributed computing environment;
partitioning the graph model into subgraphs based on a rule for partitioning the distributed computing environment into subsystems, wherein each subgraph is a model of a subsystem of objects of the distributed computing environment;
training neural networks for each subgraph based on the proposal to add the candidate application component to the distributed computing environment;
using the trained neural networks associated with each subgraph to predict the behavior of each subsystem to a proposal to add the candidate application to the subsystem; and
based on the predicted behavior of each subsystem, adding the candidate application to a subsystem or rejecting the proposal to add the candidate application.

8. The computer system of claim 7 wherein partitioning the graph into subgraphs based on the rule comprises performing one of
partitioning the graph into subgraphs such that each subgraph corresponds to a cluster of the distributed computing environment;
partitioning the graph into subgraphs such that each subgraph corresponds to objects of the distributed computing environment that receive electrical power from the same power source; and
partitioning the graph into subgraphs such that each subgraph comprises correlated objects of the distributed computing environment.

9. The computer system of claim 7 wherein training neural networks for each subgraph comprises:
for each subgraph,
for each application component of the subgraph, forming a fragment by aggregating components and metrics of one or more virtual machines used to execute the application component,
forming a candidate fragment by aggregating components and metrics of one or more VMs used to execute the candidate application component,
forming a candidate flattened subgraph from the fragments and the candidate fragment,
training a first neural network to generate a key performance indicators (“KPIs”) for each fragment of the candidate flattened subgraph, and
training a second neural network to generate a KPI of the candidate fragment.

10. The computer system of claim 7 wherein using the trained neural networks associated with each subgraph to predict the behavior of each subsystem comprises:
for each subgraph,
using a first of the trained neural networks to generate a predicted KPI for each fragment of the subgraph,
using a second of the trained neural networks to generate a predicted KPI for the candidate application, and
computing an average predicted KPI of the subgraph based on the predicted KPIs of fragments of the subgraph and a predicted KPI.

11. The computer system of claim 7 wherein adding the candidate application component to the subsystem comprises:
computing an average predicted KPI for each subsystem based on the predicted behavior of each subsystem;
for each subsystem comparing the average predicted KPI to an acceptable threshold to identify one or more of the average predicted KPIs as acceptable or unacceptable; and
adding the candidate application component to the subsystem with a corresponding with an average predicted KPI that is more acceptable than the average predicted KPIs of the other subsystems.

12. The computer system of claim 7 wherein rejecting the proposal to add the candidate application comprises:
rejecting the candidate application component for addition to the distributed computing environment when the predicted behavior of the subsystems are unacceptable; and
displaying an alert in a graphical user interface, the alert indicating that the candidate application is unacceptable for addition to the distributed computing environment.

13. A non-transitory computer-readable medium encoded with machine-readable instructions that implement a method carried out by one or more processors of a computer system to perform operations comprising:
constructing a graph model of the distributed computing environment;
partitioning the graph model into subgraphs based on a rule for partitioning the distributed computing environment into subsystems, wherein each subgraph is a model of a subsystem of objects of the distributed computing environment;
training neural networks for each subgraph based on the proposal to add the candidate application component to the distributed computing environment;
using the trained neural networks associated with each subgraph to predict the behavior of each subsystem to a proposal to add the candidate application to the subsystem; and
based on the predicted behavior of each subsystem, adding the candidate application to a subsystem or rejecting the proposal to add the candidate application.

14. The medium of claim 13 wherein partitioning the graph into subgraphs based on the rule comprises performing one of
partitioning the graph into subgraphs such that each subgraph corresponds to a cluster of the distributed computing environment;
partitioning the graph into subgraphs such that each subgraph corresponds to objects of the distributed computing environment that receive electrical power from the same power source; and
partitioning the graph into subgraphs such that each subgraph comprises correlated objects of the distributed computing environment.

15. The medium of claim 13 wherein training neural networks for each subgraph comprises:
for each subgraph,
for each application component of the subgraph, forming a fragment by aggregating components and metrics of one or more virtual machines used to execute the application component,
forming a candidate fragment by aggregating components and metrics of one or more VMs used to execute the candidate application component,
forming a candidate flattened subgraph from the fragments and the candidate fragment,
training a first neural network to generate a key performance indicators (“KPIs”) for each fragment of the candidate flattened subgraph, and
training a second neural network to generate a KPI of the candidate fragment.

16. The medium of claim 13 wherein using the trained neural networks associated with each subgraph to predict the behavior of each subsystem comprises:
for each subgraph,
using a first of the trained neural networks to generate a predicted KPI for each fragment of the subgraph,
using a second of the trained neural networks to generate a predicted KPI for the candidate application, and
computing an average predicted KPI of the subgraph based on the predicted KPIs of fragments of the subgraph and a predicted KPI.

17. The medium of claim 13 wherein adding the candidate application component to the subsystem comprises:
computing an average predicted KPI for each subsystem based on the predicted behavior of each subsystem;
for each subsystem comparing the average predicted KPI to an acceptable threshold to identify one or more of the average predicted KPIs as acceptable or unacceptable; and
adding the candidate application component to the subsystem with a corresponding with an average predicted KPI that is more acceptable than the average predicted KPIs of the other subsystems.

18. The medium of claim 13 wherein rejecting the proposal to add the candidate application comprises:
rejecting the candidate application component for addition to the distributed computing environment when the predicted behavior of the subsystems are unacceptable; and
displaying an alert in a graphical user interface, the alert indicating that the candidate application is unacceptable for addition to the distributed computing environment.
